(19) United States
(12) Patent Application Publication
(10) Pub. No.: US 2022/0050982 A1
(43) Pub. Date: Feb. 17, 2022

(54) Systems and methods to Authenticate a Security Device

(71) Applicant: Blocktag, Inc., New York, NY (US)

(72) Inventors: Nova Spivack, Sherman Oaks, CA (US); Allie Zhang, Irvine, CA (US); Chun Ming Chin, Cambridge, MA (US)

(21) Appl. No.: 17/386,696

(22) Filed: Jul. 28, 2021

Related U.S. Application Data
(63) Continuation of application No. 17/169,473, filed on Feb. 7, 2021.
(60) Provisional application No. 62/971,943, filed on Feb. 8, 2020.

(51) Int. Cl. G06K 7/14; G06K 7/10; G06K 19/10; G06K 19/06

(52) U.S. Cl. CPC G06K 7/1439; G06K 19/0614; G06K 19/10; G06K 7/10831

(57) ABSTRACT

Systems and methods to authenticate a security device are disclosed. In one aspect, embodiments of the present disclosure include a method for capturing, by an optical sensor, sequential image frames of the security device. From the sequential image frames of the security device, changes to an optical property of the security device can be measured. The optical property can include an optical refractive property. In a further embodiment, changes in optical refractive properties of the security device can be identified from the changes to the optical property measured from the security device. It can be further determined whether the changes in the optical property matches or fails to match a valid change.

### CLAIM OF PRIORITY

This application is a Continuation application of:

* U.S. application Ser. No. 17/169,473, filed Feb. 7, 2021 and entitled “Systems, methods and apparatuses of a Security Device,” (8001.US00), which claims the benefit of:

* U.S. Provisional Application No. 62/971,943, filed Feb. 8, 2020 and entitled “Systems, methods and apparatuses of a Security Device,” (8001.US00), the contents of which are incorporated by reference in their entireties.

### RELATED APPLICATIONS

This application is related to PCT Application no. PCT/US2021/17118, filed Feb. 8, 2021 and entitled “Systems, methods and apparatuses of a Security Device” (Attorney Docket No. 99013-8001.WO00), the contents of which are incorporated by reference in their entirety.

### TECHNICAL FIELD

The disclosed technology relates generally to systems, methods and apparatuses of a security device.

### BACKGROUND

Counterfeiting is a form of theft that has become increasingly problematic. Counterfeit goods span across multiple industries including everything from clothing, accessories, music, software, computer games, medications and cigarettes, to automobile and airplane parts, consumer goods, toys and electronics. The effect is detrimental to the consumers and businesses. Counterfeit products result in loss of revenue for businesses. Consumers purchase counterfeit products that are of low quality and may be exposed to health and safety issues.

### BRIEF DESCRIPTION OF THE DRAWINGS

FIG. 1 illustrates an example block diagram of a host server able to administer, generate, track, authenticate security devices in a network, in accordance with embodiments of the present disclosure.

FIG. 2A depicts a diagram an example of a security device, in accordance with embodiments of the present disclosure.

FIG. 2B depicts an image of a further example of a security device having an authenticity component with a diffractive surface, an identity component and a content component, in accordance with embodiments of the present disclosure.

FIG. 2C depicts an image of an example of a security device printed as a blank tag with micro-optics and a blank printable area, in accordance with embodiments of the present disclosure.

FIG. 2D depicts an image of an example a security device where an identity component includes a QR code, in accordance with embodiments of the present disclosure.

FIG. 2E depicts an image of a further example a security device where an identity component includes a QR code and a reflective diffraction surface as diffractive pattern B, in accordance with embodiments of the present disclosure.

FIG. 2F-FIG. 2P depict further examples of security devices, in accordance with embodiments of the present disclosure.

FIG. 3A depicts an example functional block diagram of a host server to administer, generate. track, authenticate security devices in a network, in accordance with embodiments of the present disclosure.

FIG. 3B depicts an example block diagram illustrating the components of the host server to administer, generate. track, authenticate security devices in a network, in accordance with embodiments of the present disclosure.

FIG. 4A depicts an example functional block diagram of a client device such as a mobile device that can obtain data from security devices, in accordance with embodiments of the present disclosure

FIG. 4B depicts an example block diagram of the client device, which can be a mobile device that an obtain data from security devices, in accordance with embodiments of the present disclosure.

FIG. 5A-5B depict flow charts illustrating example processes for authentication of a security device, in accordance with embodiments of the present disclosure.

FIG. 6A depicts images showing examples of unique cuts of a microlens array, viewed from the normal vector, in accordance with embodiments of the present disclosure.

FIG. 6B depicts examples of a serial identifier of an identity component of a security device, in accordance with embodiments of the present disclosure.

FIG. 7A depicts user interfaces showing using external the top left, top right and bottom right markers of a QR code to infer the position a color barcode, in accordance with embodiments of the present disclosure.

FIG. 7B depicts a graph showing how spectrum can be represented as a histogram of pixel value bins, in accordance with embodiments of the present disclosure.

FIG. 8 depicts example user interfaces for reading, decoding or authenticating a security device, in accordance with embodiments of the present disclosure.

FIG. 9 depicts user interfaces showing product information retrieved from a security device, in accordance with embodiments of the present disclosure.

FIG. 10 is a block diagram illustrating an example of a software architecture that may be installed on a machine, in accordance with embodiments of the present disclosure.

FIG. 11 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems, methods and apparatuses to authenticate a security device. One embodiment includes, capturing, by an optical sensor, sequential image frames of the security device and measuring, from the sequential image frames of the security device, changes to an optical property of the security device, the optical property including an optical refractive property. changes in optical refractive properties of the security device can be identified from the changes to the optical property measured from the security device. It can then be determined whether the changes in the optical property matches or fails to match a valid change, the valid change being predetermined for the optical property.

Embodiments of the present disclosure include systems, methods and apparatuses of a security device. One embodiment includes a security device (e.g., physical security device, tag, Blocktag) which can include, an authenticity component having A micro-optics array containing a 2D or 3D geometric array of micro-optics and/or micro-structures and/or micro-optic systems (incorporating lenses and/or mirrors and/or images created at a minute scale). The authenticity component can also include a photosensitive surface exposed to multiple diffraction patterns (e.g., A reflective-diffraction surface), creating superimposed, pseudo holographic images. The physical security device can also include an identity component. The identity component can include a color barcode which can be positioned underneath the microlens array.

The color barcode can be printed and can encode metadata describing the microlens array's physical characteristics and/or optical characteristics. For example, the physical characteristics and/or optical characteristics can include the horizontal/vertical planar distance (e.g., delta-x and delta-y in millimeters) moved by the microlens symbol in the tag's 2D plane as a device (e.g., scan device, sensor, optical sensor, mobile device, etc.) moves in 3D space relative to the security device (tag). The physical characteristics and/or optical characteristics can also include a quantified shape profile (e.g., Hu Moments, a set of 7 numbers) of one or more shapes or other features designed into the microlens. The physical characteristics and/or optical characteristics can also include the perceived depth (caused by optical illusion) of each microlens symbol design from the microlens surface.

The physical characteristics and/or optical characteristics can also include a spatial frequency determiner or measured when a microlens symbol design is repeated to produce a periodic pattern on the microlens area. The identity component can include a diffractive color barcode. The color barcode can, in one embodiment, be imprinted on the same plane as the authenticity component on a photosensitive surface. The diffractive barcode is colored when incident sources (point sources) of light cause reflective-diffraction. The identity component can encode metadata describing the diffractive surface's physical characteristics and/or optical characteristics. For example, the physical characteristics and/or optical characteristics can include, a width (in millimeters/nanometers) of the uniform gap spacing of a diffraction grating pattern on the surface, and X and Y position of the centroid of a diffraction grating pattern, and/or a width measurement and/or height measurement of a diffraction grating pattern.

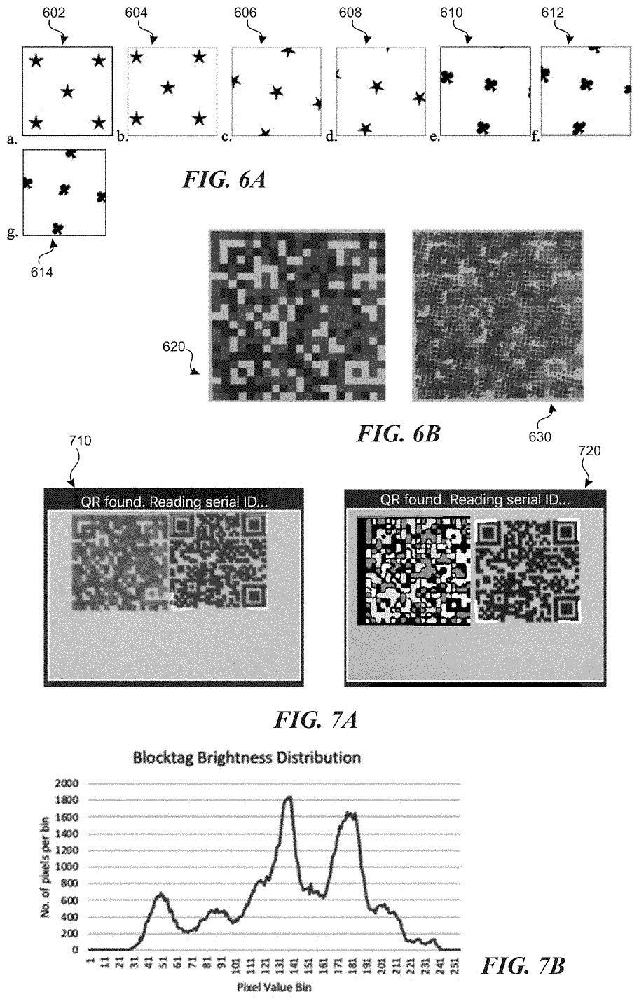

In some instances, the color barcode of the identity component can be generated or designed based on Just Another Barcode (JAB). The color barcode of the identity component of the disclosed security device can be generated or created by for example, lightening JAB's default color to increase contrast with the foreground dark microlens symbol. When flash is on, a scan device can read the color barcode symbol even if parts of the color barcode is obscured by the microlens symbol. When flash is off, the scan device can detect the microlens symbol amidst the color barcode. The color bar code of the identity component of the disclosed security device can be generated or created by for example, generating a halftone version of JAB's default solid colors. The process of half-toning creates random, irreproducible ink dot artifacts when printing. For example, an original halftone color bar code will have sharp print edges and grainy print artifacts, whereas a photocopied halftone color barcode has blurred print edges/artifacts. An example of a half-toned JAB barcode is shown in FIG. 6B. The color barcode of the identity component can also encode a serial ID to identify the microlens array or diffractive surface area as belonging uniquely to a given security device (a Blocktag). The encoded metadata or serial ID can function as authentication parameters.

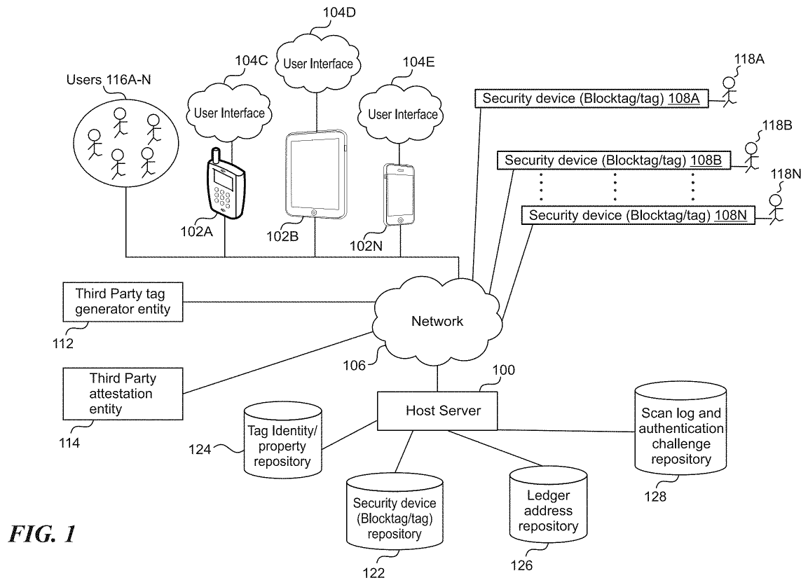

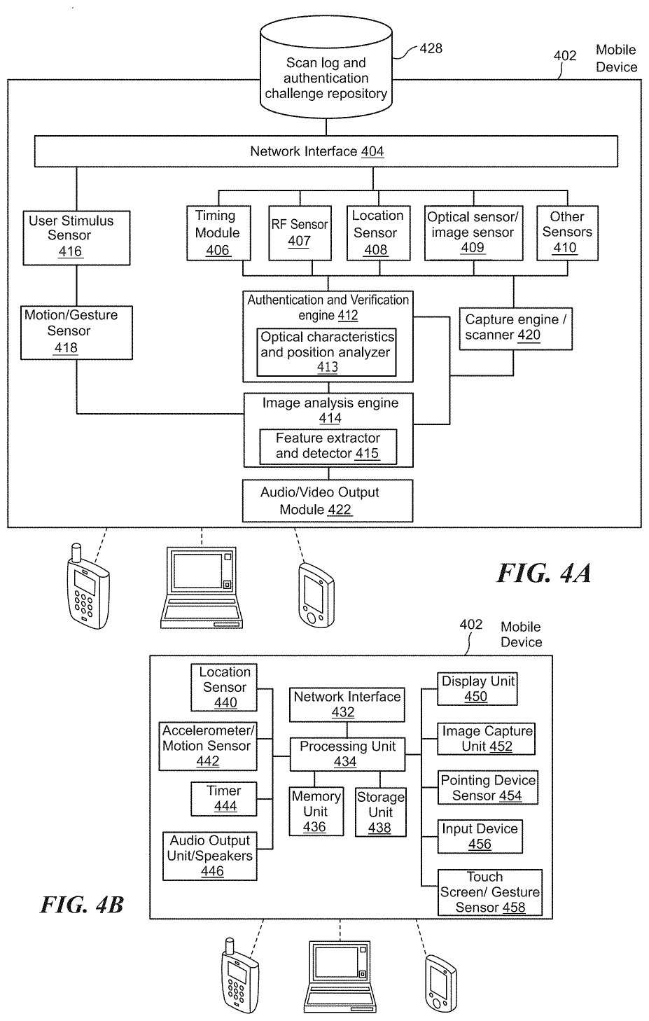

In one embodiment, the encoded metadata or serial ID can be decoded by a device (e.g. a scan device, a device 102A-N as shown in the example of FIG. 1 and/or a device 402 of the example of FIG. 4A). The device can be executing the Blocktag app or a web browser with access to Blocktag's scan API to check whether the security device (e.g., Blocktag) attached to an item is authentic without connecting to a remote sever when there is no wired or wireless network connection, IT infrastructure is poor, or when network download/upload speeds are slow. This can be a useful feature in particular when for example, using Blocktags to track cargo on ships out at sea, mark stakes to claims of land or natural resources, including land ownership claims and mining claims underground/underwater or off-Earth locations (e.g. asteroids, moons, other planets).

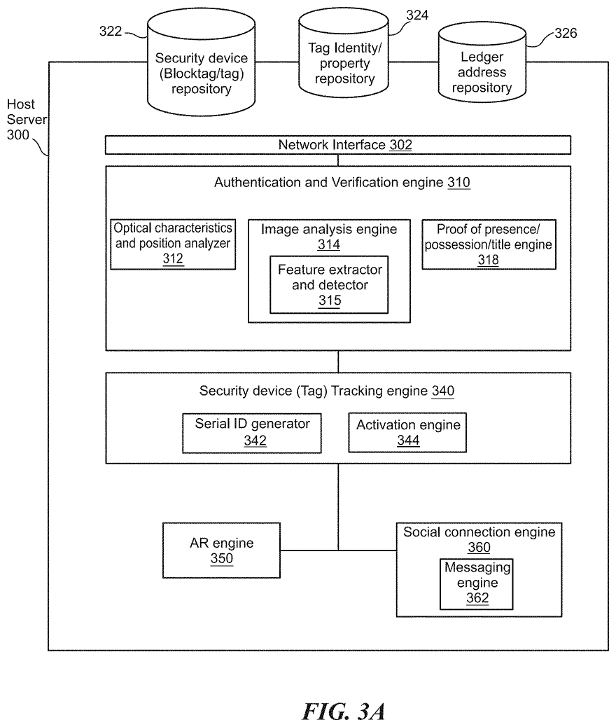

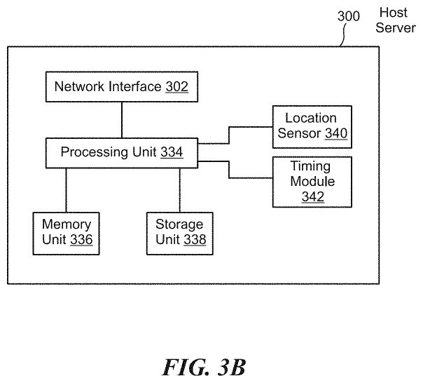

The security device (physical security device) also includes a content component. The content component can include an encoded element such as a QR code. The QR code can for example, be placed adjacent to the color barcode. In one embodiment, the QR code encodes a URL that points to content related to the tag or content related a physical item/physical good associated with the tag. The URL can include a domain belonging to a 1st party (e.g. www.blocktag.com/tag( )) as administered by a host (e.g., a host server 100 of FIG. 1 and/or host server 300 of FIG. 3A-3B) or it can belong to a 3rd party (e.g. www.contoso.com/tag( )). The QR may also be encoded with other metadata related to the authenticity component in case the color barcode runs out of offline storage space. The QR may also encode a hash of the color barcode's serial number so there there is a one-to-one correspondence between a QR and a color barcode.

One embodiment of the present disclosure includes a security device having a stationary feature and/or a non-stationary feature, arranged adjacently to one another on a surface. The security device device can, for example, include or be affixed to or integrated with a tag, label, sticker, badge, card, currency, certificate, coupon, identity card, passport, etc. The non-stationary feature refers to the optical characteristics of the non-stationary feature, which are changing, based on how it is detected or read. The non-stationary feature can also refer to a visual image which appears to be changing due to its optical characteristics. The non-stationary features generated by one or more of: a refractive lens, a refractive lens array, a lenticular lens, a lenticular lens array, a hologram, or a diffractive pattern. The stationary feature can include, for example, at least one of: a QR code, barcode, block code, serialization code or security code, or a visual illustration containing an embedded serialization code or encrypted data.

One further embodiment of the present disclosure includes a security device for brand protection. The security device can include a QR code or other bar code or block code is affixed to or printed on to a micro-optic refractive security surface. The QR code or other bar code or block code can be located in proximity to, adjacent to, the security surface. The fact that the bar code or QR code can be printed onto the same material as the refractive surface, at the time the refractive surface is made, or afterwards, provides a degree of assurance that the QR code is the authentic original QR code and not a copy of such. If it were a copy, it would not be printed on the same materials as special refractive tag or surface, since access to blank tags can be tightly controlled and only authorized parties have or can print on blank tags. Therefore any tag that has a bar code or QR code (or any type of identifier or distinct code or illustration on it) is highly likely to be authentic, so long as it is difficult for unauthorized parties to replicate or gain access to “blank” tags that do not yet have a code imprinted on them. We don't have to require potential authentication via software (although that is possible). Simply by virtue of the code appearing on the same material as the refractive element, it is likely to be authentic.

A further embodiment of the present disclosure includes a security device having a code area and a security surface. In general, the code area can include a QR code, or any other 1d/2d/3d barcode, or other static image for visual identification. Note that references to “QR code” anywhere in this entire document generally refer to any 1d/2d/3d barcode or other static image for visual identification, including but not limited to what is called a QR Code. The security surface can include a component or components having any combination of the following characteristics or properties including by way of example, reflective diffraction, transmissive diffraction, refractives, mirrors, animations, image changes, magnification, size changes, color changes, optical effects, and temperature/wavelength reactivity, special inks, ink overprinting, ink halftones, different types of inks, watermarks, taggants, microdots, random ink patterns, special pigments, etc. The security surface can be formed from materials or components having physical features of various sizes, for example, physical layers of material having micro-optics, nano-optics, exposed photosensitive substrates with reflective-diffraction patterns and/or printed high security features using inks, etc.

A security device can be viewed as having an ‘inner area’ and ‘outer area.’ In this view, the inner area includes all areas or any portion of the area within the lateral boundaries a lateral area occupied by the code area. The outer area can include all areas or any portion of the area outside of the lateral boundaries of the lateral area occupied by the code area. In one embodiment, the Inner Area of a security device, or some other region or set of regions within the Inner Area includes one or more Security Surfaces. Alternatively, the Outer Area of a security device, or some other region or set of regions within the Outer Area, includes one or more Security Surfaces. In addition, both the Inner Area and/or the Outer Area of a security device, or some other region or set of regions within the Inner Area and/or Outer Area, can include one or more Security Surfaces. Note that a micro-optical or nano-optical refractive lens, transmissive-diffraction lens, or lens array can cause the appearance of object motion, orthoparallaxis, magnification, objects floating above the surface or below the surface of the QR code, hidden objects appearing and disappearing, objects changing in size, different objects appearing and disappearing, or objects appearing to shift or animate or change shape, inside and/or around and/or beneath and/or above the Inner Area (where an object may be any symbol, set of symbols, or visual design). Lens-based refractives and diffractives can be designed to cause animations, image changes, magnification, reduction in size, color changes, and other optical effects when the QR code is observed from different angles, orientations and locations.

In addition a reflective-diffraction surface can cause the appearance of one or more holograms, or diffractive patterns, or color shifts, to appear inside, around, or beneath or on top of the Inner Area. Diffractives can be precisely designed to cause spectrum shifts or periodic patterns to appear/disappear (e.g. One or more sets of colored line grating where each line grating has its own unique spatial periodicity/frequency) when the QR code is observed from different angles, orientations and location. A light sensitive surface can change appearance (color, transparency, etc) based on the wavelength and intensity of radiation touching it.

One embodiment of the present disclosure includes a security device which can include an optical arrangement as an authenticity component and/or an encoded element as an identity component. The encoded element uniquely identifies the authenticity component. The security device can further include a content component. The physical positioning of the authenticity component, the identity component and the content component within the security device is such that each of the authenticity component, the identity component and the content component are optically detectable. For example, the identity component and the content component are optically detectable in a single time instance by a single device. The single device is generally external to the security device and the single device includes an optical sensor.

In one embodiment, the encoded element is able to be decoded to produce one or more authentication parameters which uniquely identify the authenticity component. The encoded element can be generated from one or more input parameters which define the optical properties of the authenticity component. the optical arrangement can include a microlens array. The microlens array can include, for example, a base layer having imprinted images of a microlens symbol and/or a top layer (e.g., a security surface) having refractive lenses or diffractive lenses. The microlens array can further include a color layer and ink inserted into the color layer envelopes the imprinted images of the base layer. The optical properties of the authenticity component can include, for example, one or more of, a color of the microlens symbol, a shape of the microlens symbol and a type of ink in the color layer of the microlens symbol.

In general, the identity component is irreproducible due to random physical properties. For example, the identity component can be formed from a substrate with the random physical properties in a material of the substrate. The random physical properties can be caused by irregularly distributed fibers in the material of the substrate. The random physical properties can also include non-uniform ink absorbance across the material of the substrate. The random physical properties can also include non-uniform surface texture or non-uniform surface reflectance across the material of the substrate. In a further embodiment, the identity component is printed or deposited to have the random physical properties, which can include, for example, surface irregularities or grain size irregularities created through printing or deposition. Note that the identity component can be physically attached to the authenticity component or algorithmically related to the authenticity component. In one embodiment, the unique identifier of the identity component is printed as a color barcode which can include a high capacity storage color barcode.

In one embodiment, the optical arrangement includes a diffractive surface. The optical arrangement can include, one or more of, micro-optics, nano-optics, a lenticular lens array, a holographic medium, a refractive lens, a refractive lens array, a mirror, and a micro-image. Note that an optical characteristic of the optical arrangement can vary based on an observation angle with the security device and a visual appearance of the encoded element may not vary based on the observation angle with the security device. The observation angle is formed between an observer and the security device and the observer can be one or more of a human eye, a light sensor, a still image camera, a video camera, an optical sensor. In one embodiment, the encoded element includes at least one of: a QR code, barcode, block code, a serialization code, a security code, a visual illustration having an embedded serialization code or encrypted data. The content component includes at least one of: a URI, a URL or bar code. The content component can also includes a logo having a coded identifier. In one embodiment, the encoded element is printed with microdots or random ink patterns.

One embodiment of the present disclosure includes a security device having an authenticity component having a reflective-diffractive surface formed in a first plane of the security device and an identity component. The identity component can be optically coupled to the authenticity component. In one embodiment, the identity component is also formed in the first plane of the security device. The authenticity component can produce a first set of diffractive images under stimulation by an optical source and the identity component can produce a second set of diffractive images under stimulation by the optical source. The identity component can be optically coupled to the authenticity component through superimposition of the first set of diffractive images and the second set of diffractive images. Moreover, the first intensity level and the second intensity level are generally detectable by the optical source and are of measurable magnitude by the optical source.

In one embodiment, a first lateral area occupied by the authenticity component in the first plane at least partially overlaps with a second lateral area occupied by the identity component. In an alternative embodiment, a first lateral area occupied by the authenticity component in the first plane does not overlap with any portion of a second lateral area occupied by the identity component in the first plane of the security device. The authenticity component can produce a first set of diffractive images at a first intensity level under stimulation by an optical source and the identity component can produce a second set of diffractive images at a second intensity level under stimulation by the optical source. A lateral distance between the first lateral area and the second lateral area is such that the first intensity level and the second intensity level are measurable. The security device can further include a content component formed in a second plane of the security device. The second plane can be disposed on a side of the first plane that is optically accessible or detectable. The content component can include a resource identifier in the form of a URI or a machine-readable code.

One embodiment of the present disclosure includes a security device having an authenticity component having a transmissive-diffractive surface formed in a first plane of the security device and/or an identity component, where the identity component can be optically coupled to the authenticity component. In one embodiment, the identity component is formed in a second plane of the security device and the second plane is disposed vertically from the first plane. The second plane can be disposed on a side of the first plane such that the second plane does not obstruct optical stimulation or optical access of the first plane. In one embodiment, the authenticity component is formed in the first plane within a first lateral area and the first lateral area is delimited by a second lateral area occupied by the identity component in the second plane of the security device. The security device can further include a content component formed in a third plane of the security device and, the third plane can be disposed on either side of the first plane of the security device. Note that the third plane is generally substantially parallel to the first plane and the second plane is substantially parallel to the first plane. In one example of the security device, the transmissive-diffractive surface can include a microlens array and the identity component includes a color barcode or a diffractive barcode.

Note that a visual appearance of the identity component is generally visually stationary and does not vary based on an observation angle with the security device and that an optical characteristic of the authenticity component typically varies based on an observation angle with the security device. Moreover, a visual appearance of the content component is generally visually stationary and does not vary based on an observation angle with the security device. In one embodiment, vertical distances between the first plane, the second plane and the third plane are determined based on a focal length of the observer. Moreover, a lateral distance between the authenticity component and the content component can be determined or configured based on a focal length of the observer such that the content component is decoded, the authenticity component is detected, and identity component is detectable and able to be decided in a single time instance by the observer. In addition, a change in a relative positioning between the authenticity component and the content component and a change in the lateral distance between the authenticity component and the content component is used to determine if the security device has been altered or tampered with.

Blocktags can include materials such as micro-lenses (e.g., sub-optics or lenticular lenses), holograms, diffractives, refractive components or combinations of these, They can also include covert elements such as quantum dots, invisible inks, IR or UV dyes, or other hidden elements such as steganographic elements encoded into seemingly random information or hidden aspects of the tag design.

Blocktags can be used to make a signature block on a paper document. A Blocktags powered signature block sticker for legal documents. Two variations. (1) a signature strip that can be signed by pen appears above a strip of microlens as a signature block sticker that can be attached to a document. First attach it and then sign it with ink. Once it is signed the system can use the signature as the stationary element to learn and analyze against the non-stationary element in the lens. So the signature replaces the QR code in this case as it is totally unique. A signature can also be added to a strip above a QR (or bar code or block code etc.) and lens to include both. (2) Blocktags are printed with a person's signature already on them—so they can be affixed or attached onto things.

A pen and ink signature is not secure, easy to counterfeit, impossible to authenticate. A signature signed on a Blocktag signature line could be a learned item. Each time the user signs, the user teaches the system (e.g., the host server 100 of FIG. 1 and/or the host server 300 of FIG. 3A-3B and/or the device 102A-N as shown in the example of FIG. 1 and/or the device 402 of the example of FIG. 4A) that signature on the Blocktag. The unique relationship between that particular signature (different every time) and the other stationary and non-stationary elements of the tag is learned and stored on the blockchain. In some instances, that signature block can only be used once, on the document it is placed on.

A photo of the signature block on the document can be stored for example, on the blockchain. So when signing you use a blank signature block tag. The blank tag could already be serialized to a particular person. So for example, I order 1000 and they are serialized and registered so that only I can use them. Then when I sign one, it is learned, and registered onto the blockchain. That signature can never be used again by anyone. It exists only on a particular document. It can be authenticated on the paper document by anyone with Blocktag. Also, when registering tag to a database, signer (and any other party that adds a signature) can sign the tag data (including signature) with a private key into the database (which can be a distributed ledger such as a blockchain) to prove both timestamp and identity of the party signing.

Another example is a Blocktag powered “stamp” for stamping onto documents or tax stamps or tourist visa stamps on pages. In this case a stamp like applicator tool could contain a roll or cartridge or set of Blocktag signature blocks and could affix on Blocktag per stamping motion. Stamp it on. It may then be signed, or it may be a tag that does not need to be signed. Stamping could also trigger activation of the tag via a separate device or via a camera in the stamper.

Blocktags can also be used as a notary public stamp on notarized documents and in notary public record books. This is more secure than the Notary signing with ink or using a notary stamp. Anything that can be stamped with a rubber stamp, plastic stamp, metal stamp, ceramic stamp and some form of ink or dye can be replaced with a Blocktags sticker and made more secure. The Blocktags sticker can be signed and/or serialized and registered to the party who holds the authority to stamp or certify. They affix the sticker to a document in order to “stamp” that document with their certification or signature.

A further example of Blocktag applications includes buyer driven scenarios are like vending machines, Instead of pressing the button on the vending machine that points to the product you want, then insert coins/swipe credit card or tap NFC with your phone, now the user points their phone camera at the product you want through the vending machine's window, payment is processed automatically on the system (assuming bank account/credit card is registered with the system first) and product dispenses automatically, Vending machine owners (e.g., a third party or third party tag generator entity 112 of the example of FIG. 1) can integrate in this payment processing approach because they have more visibility on when product(s) are bought and the demographic of buyers if Blocktag app uses Facebook login Additionally Blocktags could potentially work from farther away than NFC and still be passive.

Another efficiency here is that in the workflow of the supply chain there are basically 3 to 4 times when a cannabis product gets a code on it. At the start of the process, a brand (e.g., a third party or third party tag generator entity 112 of the example of FIG. 1) orders boxes or packages for its product. Those are printed and they could be printed with a blank square (even a specially designed one with fiduciary marks on the corners), adjacent to theft own UPC or bar codes of the brand (e.g., a third party or third party tag generator entity 112 of the example of FIG. 1). They then only have to add the Blocktag and the system (e.g., the host server 100 of FIG. 1 and/or the host server 300 of FIG. 3A-3B and/or the device 102A-N as shown in the example of FIG. 1 and/or the device 402 of the example of FIG. 4A) can eliminate the serialization step. In this case serialization would be achieved when they train the system (e.g., the host server 100 of FIG. 1 and/or the host server 300 of FIG. 3A-3B) on the new “Blocktag” comprised of their code plus the Blocktag stuck into the blank zone. if what they try to train is already in the system as another Blocktag, then the system won't let them activate it. That way they have to ensure that each new Blocktag that they train is not a copy of any previous one known to the system (e.g., the host server 100 of FIG. 1 and/or the host server 300 of FIG. 3A-3B and/or the device 102A-N as shown in the example of FIG. 1 and/or the device 402 of the example of FIG. 4A).

The system can then serialize the new Blocktag from the hash of something about the two features, on of a host host (e.g., Blocktag Manufacturer, the host entity which hosts or administers the host server 100 of FIG. 1 and/or the host server 300 of FIG. 3A-3B) and one of the third party (e.g., third party tag generator entity 112 of the example of FIG. 1), and this becomes the unique serial code for the tag in our system. This solution eliminates the need to have banknote print QR codes on Blocktags, if the customer (e.g., a third party or third party tag generator entity 112 of the example of FIG. 1) wanted to print their own.

### Fabrication and Manufacture

In general, the security device can be printed onto thin films (polymer, metalized, etc.) or sheets of material that can then be cut to make tags, labels, stickers, security tape, etc. The security device can have a surface on which there is at least one micro-optical element that generates at least one changing optical feature when the angle between the device and an observer is changed. The optical element can be adjacent to at least one stationary visual element that does not change in appearance when the angle between the device and an observer is changed. The security device may be, associated with, attached to, affixed to, integrated with, or otherwise associated with, a tag, label, sticker, badge, card, currency, certificate, coupon, identity card, passport, etc.

The optical element can include one or more of: a refractive lens, a hologram, a mirror, a micro-image. Note that the observer may be any of the naked eye, a light sensor, a still image camera, a video camera, an optical sensor or a device (e.g., a device 102A-N as shown in the example of FIG. 1 and/or a device 402 of the example of FIG. 4A). The stationary visual element can include one or more of: a QR code, barcode, block code, serialization code, security code, or other 2d serialization encoding. The security device can be printed as a security film that can be cut into shapes. In one embodiment, a microlens or some other security surface can be paired with a QR code and/or serialization code. In some examples, one or both are covered with a scratch-off material.

The color barcode identity element underneath a microlens or QR content element can be printed using materials such as water or oil based ink, powder based toner, silicon crystals on clear UV color, microdots. Material that can be used include those with easy accessibility from various print devices such as desktop home or office printers, industry-grade factory printers, point of sale receipt printers, portable/mobile pocket/backpack-sized photo printers, industrial label printers or 3D printers. Print devices that can also be used include those which deposit ink in additive ways such as ink-jets, laser-jet, ultraviolet curing, sublimation, heat transfer, digital offset, 3D printing, or subtractive ways such as laser engraving/etching, chemical etching, computer Numerical Control machining (drilling, boring, milling, reaming etc.).

### 1st Party Versus 3rd Party Assembly of Authenticity, Identity and Content Components

Components of security device having a microlens array or diffractive surface can be manufactured and assembled in a few ways. For example, a security device can manufactured and assembled in whole by a 1st party (e.g., Blocktag Manufacturer, a host entity which hosts or administers a host server 100 of FIG. 1 and/or host server 300 of FIG. 3A-3B) as a sticker that a 3rd party (e.g., Blocktag customer, or third party tag generator 112 as shown in the example of FIG. 1) may affix on or integrate with their physical goods.

In another example, a security device can be manufactured in part by the 1st party and assembled by the 3rd party (Blocktag Customer). For example, for a security device with the authenticity component having a microlens array can be designed and manufactured by the 1^{st} party (e.g., Blocktag Manufacturer, a host entity which hosts or administers a host server 100 of FIG. 1 and/or host server 300 of FIG. 3A-3B. The micro-lens array can then be fabricated as a microlens sheet. The identity component (e.g., a color barcode or other features) of the security device can be created, generated, designed, specified and/or printed behind the transparent microlens and shipped to the 3rd party. For a security device with the authenticity component having reflective-diffraction surface, the authenticity and identity component can be imprinted on the same photosensitive surface plane via light exposure generated in a sticker form factor.

The 3rd party (e.g., Blocktag customer, or third party tag generator 112 as shown in the example of FIG. 1) can then add the microlens/diffractives with a color barcode to a preexisting UPC/Barcode/QR on their product (printed on the packaging). The packaging can have a blank square where the microlens/diffractives sticker can be stuck on. When the 3^{rd} party orders packaging, they can be supplied with stickers or labels (having a microlens array or diffractives, but without QR) to stick onto the white square on their packaging next to their own QR or other content. Next, a scan device takes a picture of a legacy QR and Blocktag, records and activates the legacy QR's link and Blocktag color barcode's serial ID as a unique link-ID pair. Connecting a Blocktag with preexisting UPC/Barcode/QR solves the problem of integration with legacy systems of QR printed on packaging and integration with current payment gateways in Point Of Sale (POS) scenarios. This solution also bridges the disconnect between a merchant's supply chain tracking system and what happens on the demand side post-sales after customer buys product off the shelf.

Blocktag's proof of ownership claim can enable people to use Blocktag for product Point Of Sale (POS) transactions. POS scanning with Blocktags is not limited to in-person transactions but also remote transactions over video or images for example in social e-commerce. For example. Buyer shows seller a Blocktag based payment card in-person or over a webcam video and seller scans card with phone to authenticate. Seller then scans another Blocktag on the product to be sold to the buyer who owns the Blocktag card. In this way, funds are transferred from buyer's Blocktag card to seller and transaction is registered on the blockchain saying product ownership is transferred from seller to buyer.

FIG. 1 illustrates an example block diagram of a host server 100 able to administer, generate. track, authenticate security devices 108A-N in a network 106, in accordance with embodiments of the present disclosure.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100. For example, the client devices 102A-N can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device, a head mounted device, a smart watch, a goggle, a smart glasses, a smart contact lens, and/or any other portable, mobile, hand held devices, etc. The input mechanism on client devices 102A-N can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

The client devices 102A-N, security devices (Blocktag/tag) 108A-N, its respective networks of users 118A-N, a third party tag generator entity 112, and/or a third party attestation entity 114, can be coupled to the network 106 and/or multiple networks. In some embodiments, the devices 102A-N and host server 100 may be directly connected to one another. In one embodiment, the host server 100 is operable to administer, generate. track, authenticate security devices in a network. The host server 100 can transmit, receive data or information regarding security devices 108A-N via a user devices 102A-N.

Functions and techniques performed by the host server 100 and the components therein are also described in detail with further references to the examples of FIG. 3A-3B.

In general, network 106, over which the client devices 102A-N, the host server 100, the security devices 108A-N, the third party tag generator entity 112, and/or the third party attestation entity 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to the security device repository 122, the tag identity/property repository 124, the ledger address repository 126 and/or the scan log and authentication challenge repository 128. The host server 100 is able to generate, create and/or provide data to be stored in the security device repository 122, the tag identity/property repository 124, the ledger address repository 126 and/or the scan log and authentication challenge repository 128. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc. The repositories can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package.

### High Level Descriptions

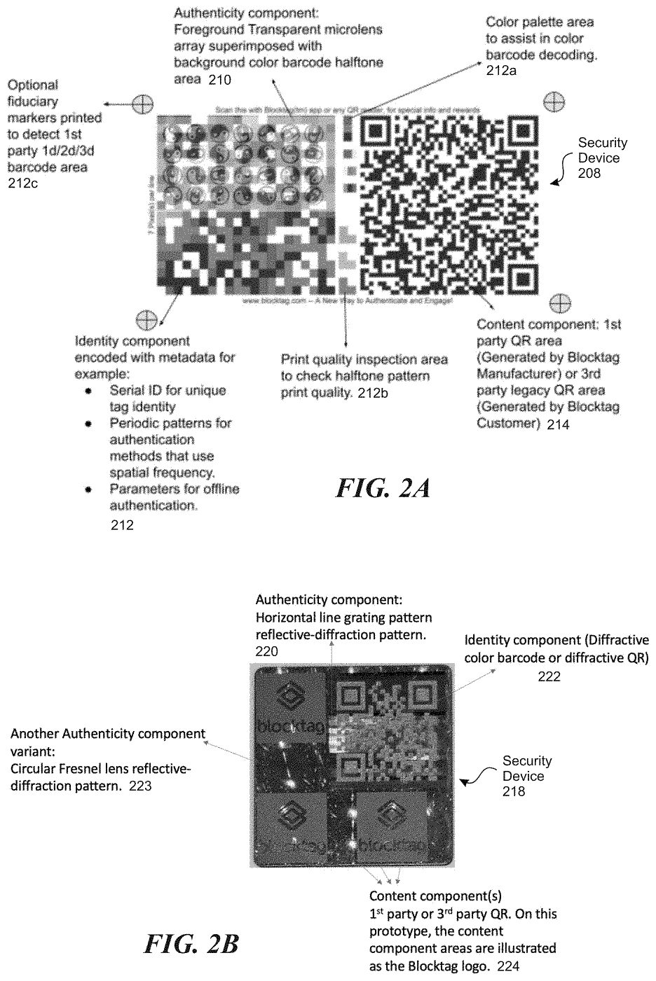

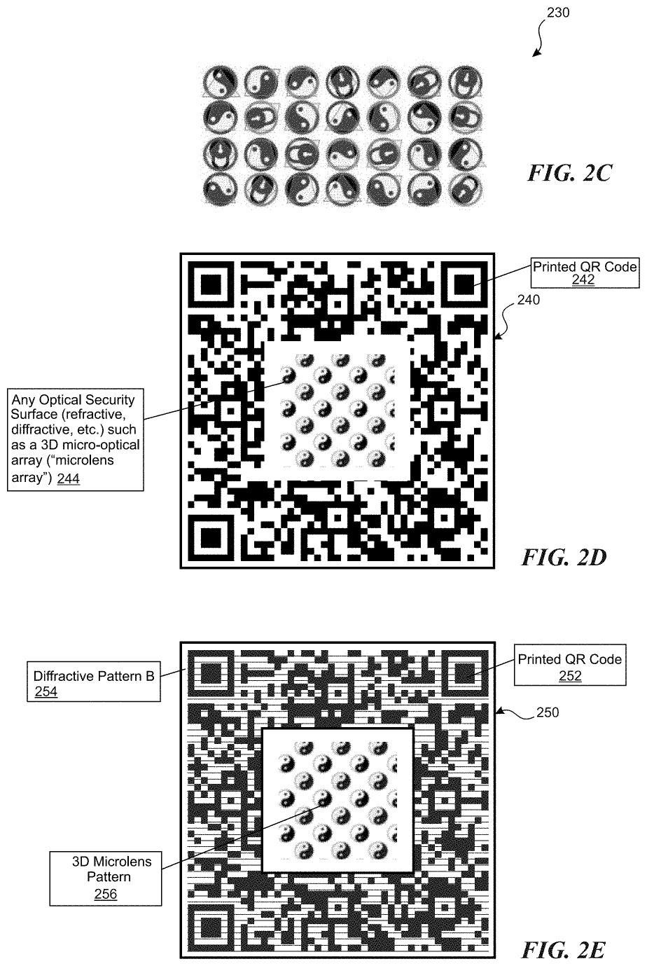

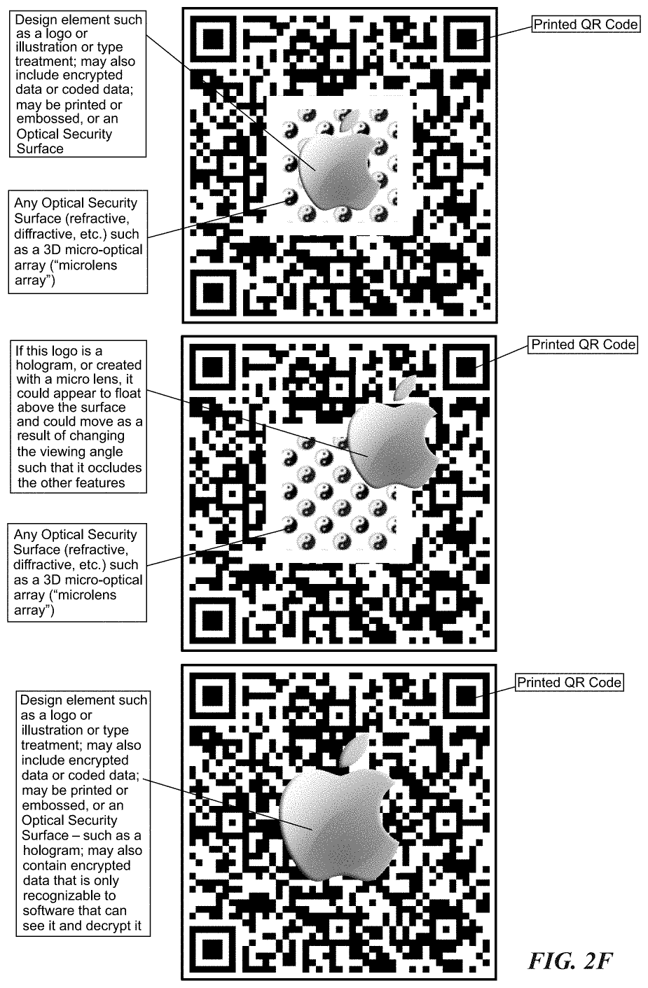

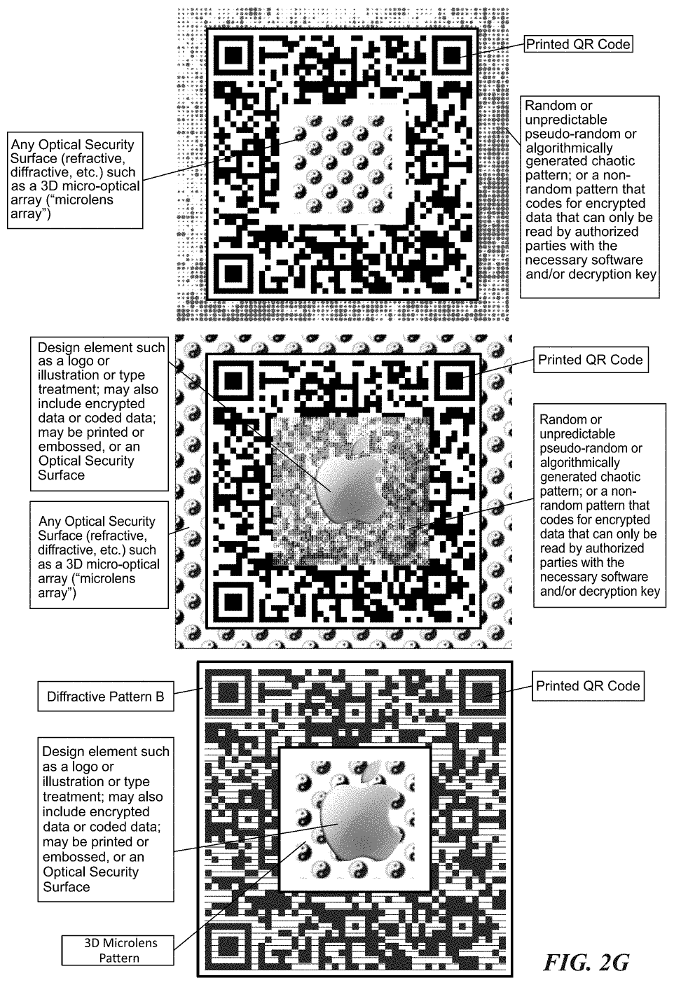

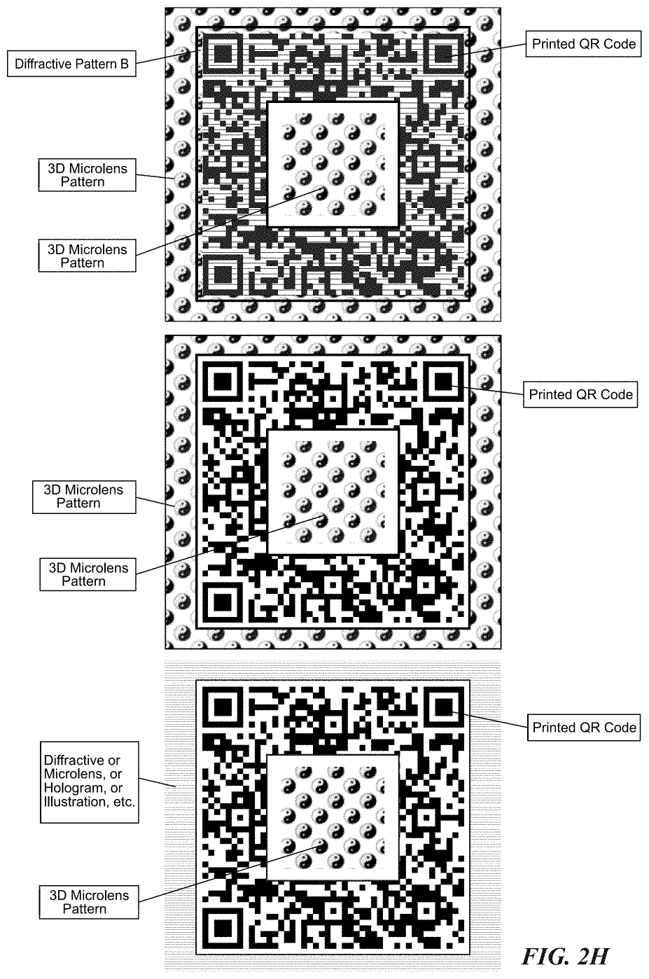

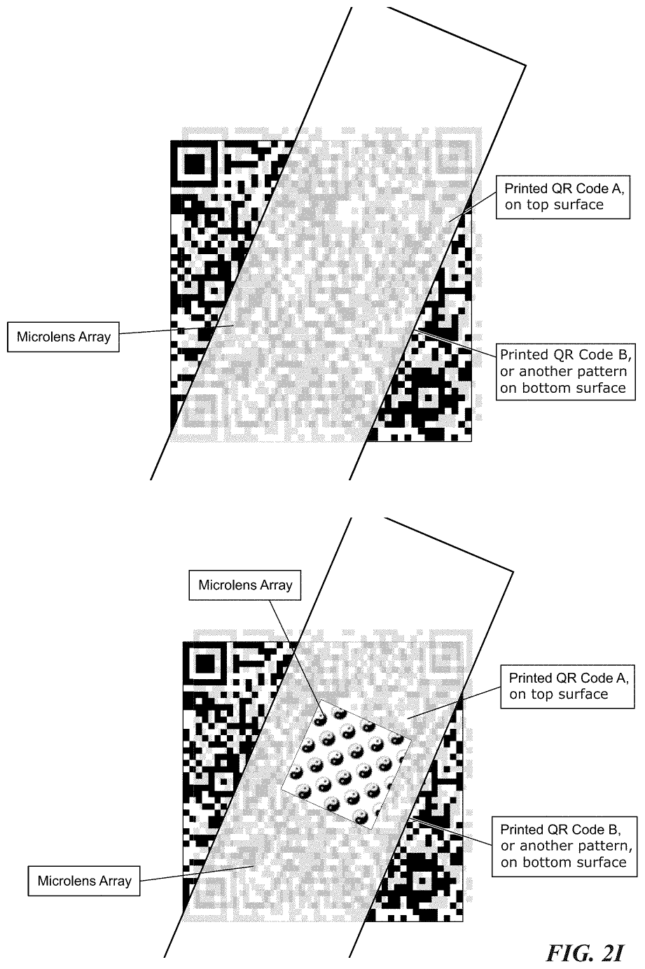

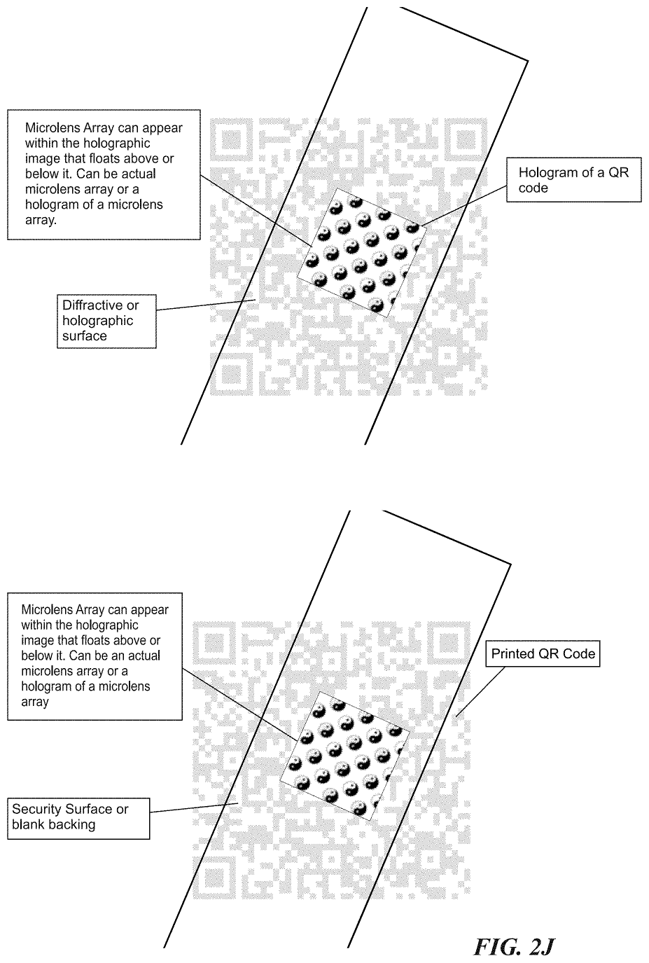

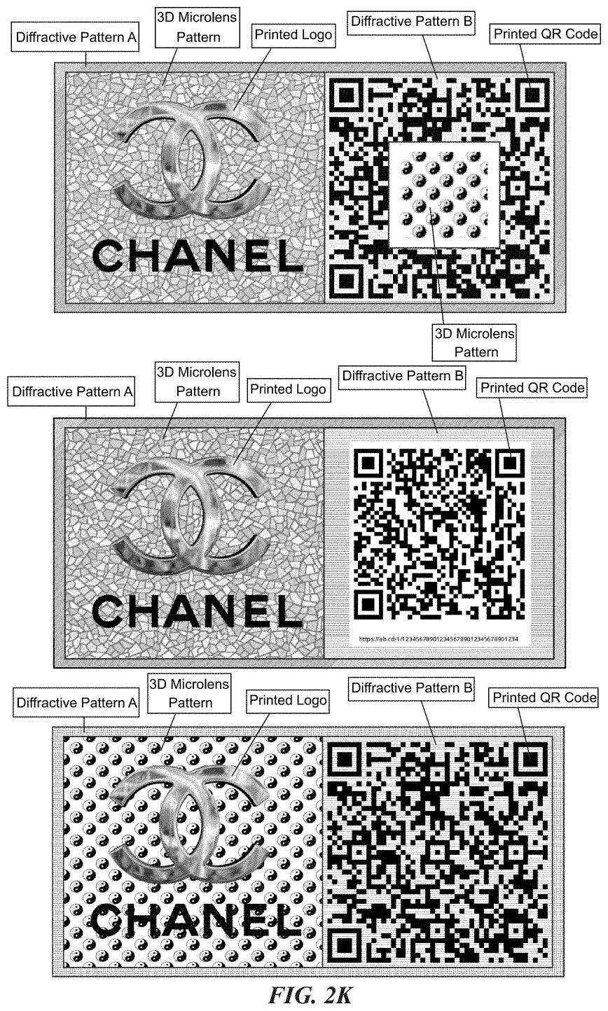

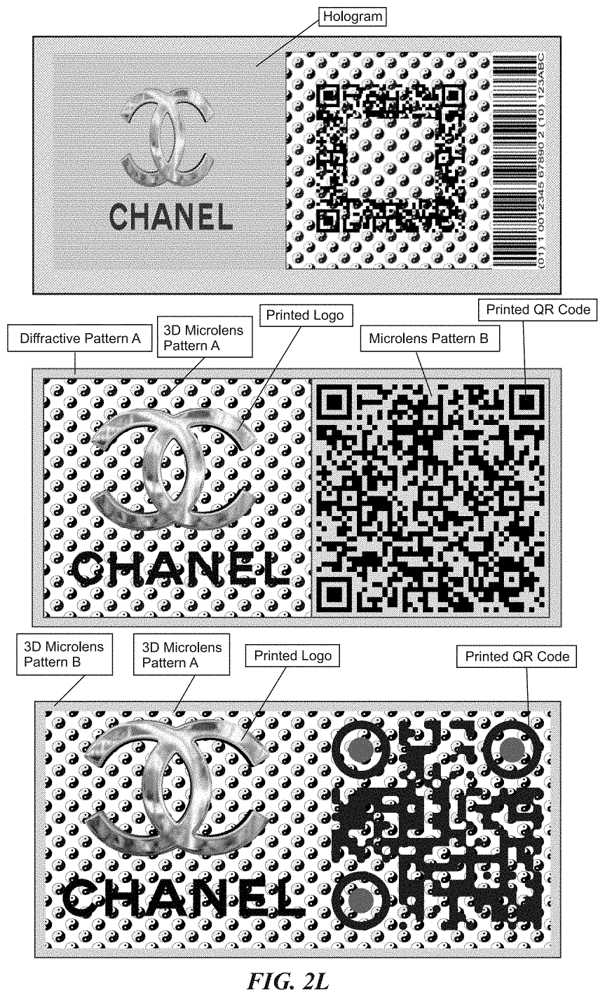

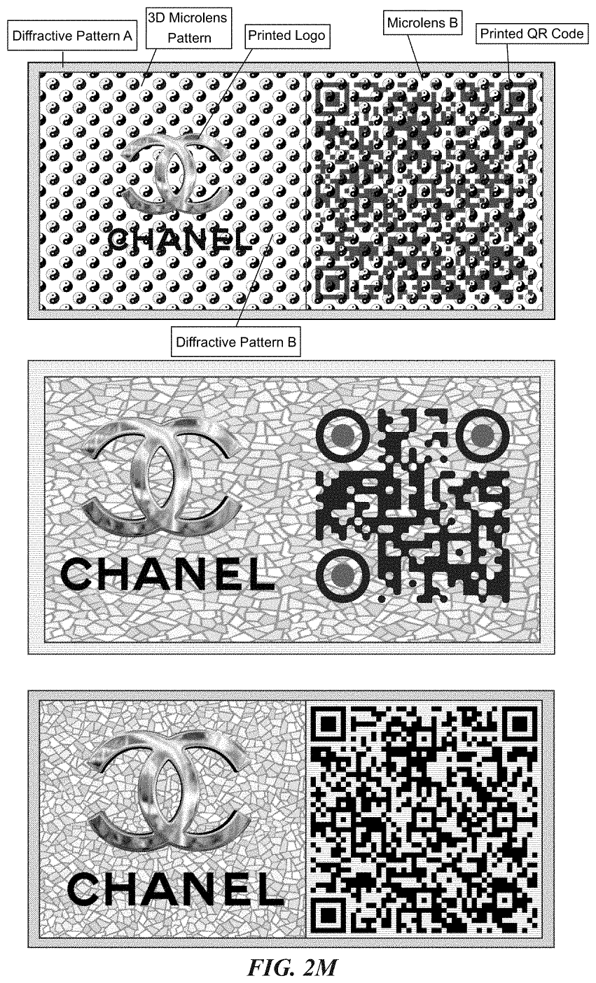

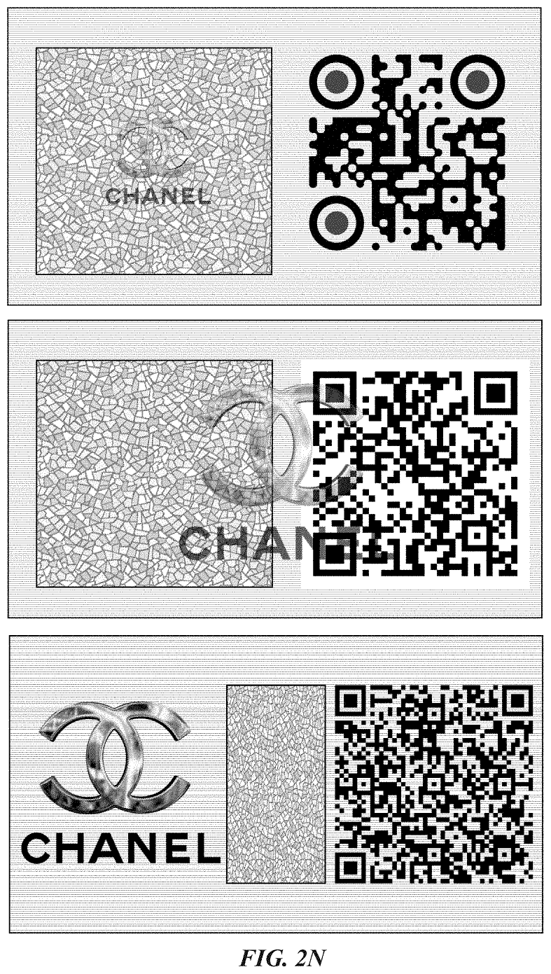

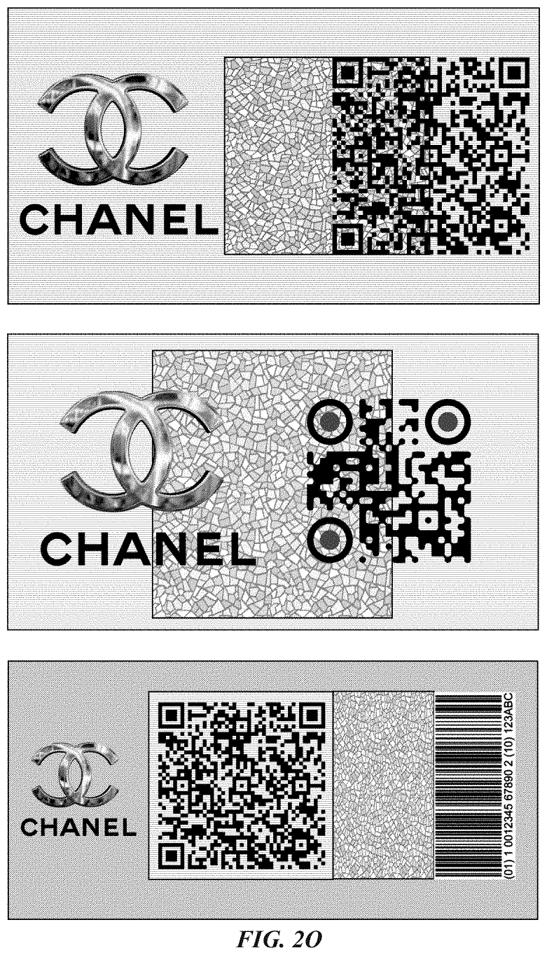

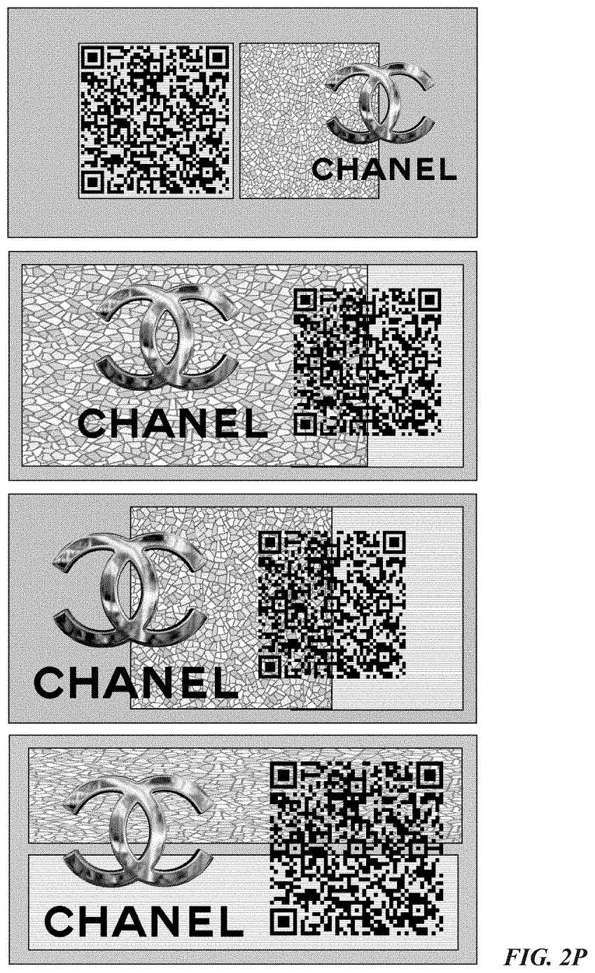

The disclosed security device (e.g., a tag, a “Blocktag”, a security device 108A-N as shown in the example of FIG. 1 or security devices as shown in the examples of FIG. 2A-2P) can include a material on which a QR code is printed, integrated with one or more Security Surfaces. That the Security Surfaces are inside or outside the Code Area. In a further embodiment the disclosed security device (e.g., a tag, a “Blocktag”, a security device 108A-N as shown in the example of FIG. 1 or security devices as shown in the examples of FIG. 2A-2P) can include in one embodiment an authenticity component, an identity component. The disclosed security device can further include a content component. The security device provides anti-counterfeit features and properties. For instance, the security device cannot be copied (based on exclusive material and technology). A physical item or product tagged with a Blocktag can be used for anti-counterfeit function (Blocktag-item relationship)

The security device can provide Proof of Presence functionalities. For instance, the security device can prove that a person is in close proximity or within line of sight of a physical item or product tagged with a Blocktag. To perform proof of presence, a person can scan the Blocktag in a single time instance to perform authentication (this is a Single time instance Blocktag-item-person relationship). For example: a Blocktag tagged item that can be seen through a store window can be scanned to prove the user's relative physical proximity with the tag. The security device can also provide Proof of Possession functionalities. For instance, the security device can determine that a person is not only in close proximity and/or within line of sight of an item, but also has physical control/possession of the security device. To perform proof of possession authentication, the user can the Blocktag across multiple time instances to authenticate the Blocktag (Multiple time instance Blocktag-item-person relationship). Proof of Possession can imply Proof of Presence, but Proof of Presence generally does not imply proof of possession. For example, a Blocktag tagged item that is held in in one's hand can be scanned to prove the person's physical control over the tag.

Note that the identity component of the security device (e.g., a tag, a “Blocktag”, a security device 108A-N as shown in the example of FIG. 1 or security devices as shown in the examples of FIG. 2A-2P) gives a unique identifier (e.g. a serial ID) to the authenticity component of tag. The identity component cannot be copied or reproduced (based on physical material randomness that is difficult or impossible to replicate). Specifically, physical material randomness can exist in both the substrate and the printing/deposition method. For substrate, this includes fibers in substrate (e.g., paper), non-uniform Ink absorbance, surface texture, non-uniform surface reflectance etc. For printing/deposition. This includes uneven or random ink dispersion and using printing methods that cause surface regularities or grain size irregularities (for powdered material that is deposited). The identity component of the security device also attaches itself to the authenticity component of the security device. The attachment can be physical or algorithmic. The unique identifier and attachment ensures the identity component cannot be separated from the authenticity component. The authenticity component ensures that the identifier is real, increasing the chances that the identifier is unique. If the identity component exists but the authenticity component is missing, then someone may make unauthorized copies rendering it non-unique.

Non-unique tags cannot describe a singular item reliably. If the authenticity component exists but the identity component is missing, then the tag cannot be linked to a singular item. Reading a tag without identity would only give a real/fake response, rather than a reliable identifier that can be used to look up data about the specific tag (and item it is attached to). These capabilities guard against adversarial attack scenarios, for example, a bad actor transferring the authenticity component of an original tag onto a clone tag. In general, the content component of the security device can include a URI, a bar code, QR code or other 2D code created by a 1st party (e.g., a host server 100 as shown in the example of FIG. 1 and/or host server 300 as shown in the example of FIG. 3A-3B), Blocktag manufacturer) or 3rd party (e.g., 3^{rd} party tag generator entity 112 as shown in the example of FIG. 1).

Note that a tag says that QR q, that points to URL k, is on the tag with identity x and authenticity y. When launched in by the host server (e.g., the host server 100 as shown in the example of FIG. 1 and/or host server 300 as shown in the example of FIG. 3A-3B), content for (q, k,x,y) can be retrieved and presented. If not launched by the host server then the content for k can be retrieved and presented. For example:

Case 1: Launched in Blocktag application (e.g., by host server components as shown in the examples of FIG. 3A-3B and/or client side components as shown in the examples of FIG. 4A-4B)
Blocktag application can retrieve and depict the data associated with identity X (e.g., date of manufacture, UPC, safety certifications, product info) and tag metadata (e.g.,. tag id, tag version)
Blocktag application can authenticate the tag and shows the user the likelihood the tag is real/fake
Blocktag application can redirect to the URL k, or gives the option to the user to see the URL k that the tag activator set.

Case 2: Launched in a 3rd party application or component (e.g., standard or 3^{rd} party QR code reader)
A standard QR code reader reads and understand plain QRs, so can access to the URL k that exists in the QR code.
The URL k can link to a Blocktag URL, which is a web version of the Blocktag application.
for devices (e.g. a user device or device 102A-N as shown in the example of FIG. 1 and/or a device 402 of the example of FIG. 4A) which do not support full sensor/camera access, so the web page can depict information depicted via the Blocktag application shows except for Authenticity result.
For devices (e.g. a user device or device 102A-N as shown in the example of FIG. 1 and/or a device 402 of the example of FIG. 4A) that support full sensor/camera access for web pages, the web page can support everything the Blocktag app does.

Note that in both cases, URL k links to either a 1^{st} party Blocktag controlled page or a 3rd party Blocktag customer page (e.g., 3^{rd} party tag generator entity 112 as shown in the example of FIG. 1). This URL is unchangeable once printed in a tag. Blocktag clients (e.g., 3^{rd} party tag generator entity 112 as shown in the example of FIG. 1) can go through the Blocktag administrator panel to update the data associated with their tags, including the addition of a redirection URL (e.g., a product page).

FIG. 2A depicts a diagram an example of a security device 208, in accordance with embodiments of the present disclosure.

The disclosed security device 208 (e.g., a tag, a “Blocktag”, a security device 108A-N as shown in the example of FIG. 1 or security devices as shown in the examples of FIG. 2A-2P) can include in one embodiment an authenticity component 210, an identity component 212. The disclosed security device can further include a content component 214. In one example, the security device 208 e.g., a tag, a “Blocktag”, and/or any of the security devices 108A-N as shown in the example of FIG. 1) includes an authenticity component/element 210 having microlens array that has refractive and transmissive-diffraction properties. The authenticity component/element 210 can also include diffractive surface that has reflective-diffraction properties. The diffractive surface can be cut and used as diffractive strips/confetti form factor. The authenticity component/element 210 can also include other lenticular/holographic mediums that can be used to create multiple images on the same plane. The identity component/element 212 of the security device 208 can include a printed ink serialization pattern in the form of a high capacity storage color barcode printed behind the microlens array. The content component/element 214 can include a QR printed with special or normal ink next to the authenticity component/element 210 and identity component/element 212.

In some embodiments, the identity component 212 includes further sub components to assist in the decoding the color barcode. For example the identity component 212 can include a color palette 212a for a scan device (e.g. a user device or device 102A-N as shown in the example of FIG. 1 and/or a device 402 of the example of FIG. 4A) to interpret or to read the different perceived colors on a color barcode. The identity component 212 can also include a print quality palette 212b for the scan device to determine if the halftone patterns are printed clearly on a color barcode. The identity component 212 can also include fiduciary markers 212c to detect or determine a location of identity component. The physical/spatial relationships between the different components of the security device 208 are described as follows. Since, the authenticity component 210 of the security device 208 includes a microlens array (having refractive and transmissive diffraction properties), the spatial relationships with identity component 212 and content components 214 are as follows. In general, the vertical and lateral range of distances between the authenticity component 210, (e.g., a microlens array), the identity component 212 (e.g. a color bar code) and the content component 214 (e.g., QR code) depends on a focal distance of an optical sensor (e.g., the focal distance of an imaging unit or camera lens of a scan device (e.g. a user device or device 102A-N as shown in the example of FIG. 1 and/or a device 402 of the example of FIG. 4A).

Focusing should clear/sharp enough in a single time instance during imaging to:
Detect and decode the content component 214 (e.g. QR)
Detect and track the symbols/patterns on the authenticity component 210 (e.g., a microlens array).
Detect and decode the color barcode as well as detect the distinct print artifacts of the identity component 212 (e.g., a printed color barcode) and halftone patterns through the authenticity component 210 (e.g., a microlens array) layers.

Vertical positioning:
Given an authenticity component 210 (e.g., a microlens array) that is transparent and an identity component 212 (e.g., a printed color barcode) that is opaque, the printed color barcode 212 must be positioned under the microlens array 210.
A content component 214 (e.g., QR) that is opaque can be positioned vertically above or below the microlens array 210.
In some embodiments, the vertical range between the authenticity, identity and content components are generally within a few centimeters.

Lateral positioning:
The authenticity component 210 (e.g., a microlens array) is laterally contained within the lateral area occupied by the identity component 212 (e.g., a printed color barcode) so that it is clear the whole authenticity component 210 (e.g., a microlens array) is identified by or associated with the identity component 212 (e.g., a printed color barcode).
The content component 214 (e.g., QR) generally does not overlap with the identity component 212 (e.g., a printed color barcode) or the authenticity component 210 (e.g., a microlens array).
The lateral range between the content component 214 (e.g. QR) and the identity component 212 (e.g., a printed color barcode), with the microlens array contained with the color barcode, is generally in the order of magnitude of a few centimeters. The scan device (e.g., a user device or device 102A-N as shown in the example of FIG. 1 and/or a device 402 of the example of FIG. 4A) can be placed further away from a Blocktag in 3D space to capture identity and content components that are laterally spaced further apart on the 2D plane of a Blocktag.
FIG. 2B depicts an image of a further example of a security device 218 having an authenticity component 220 with a diffractive surface, an identity component 222 and a content component 224, in accordance with embodiments of the present disclosure.
The security device 218 includes the authenticity component 220 having a diffractive surface (reflective-diffraction surface), the physical/spatial relationships with the identity component 222 and the content component 224 are described as follows.

Vertical positioning:
The identity component 222 is generally vertically disposed or located in the same surface plane as the authenticity component 220. This vertical positioning is specific to the diffractive pattern manufacturing process on a photosensitive surface to produce multiple superimposed diffractive images on the surface, where the diffractive image refers to the identity component 222 or the authenticity component 220. Diffractive image(s) superimposition ensures physical attachment between the identity component 222 and the authenticity component 220.
The content component 224 is generally vertically disposed or located on top of the opaque reflective-diffraction surface (which includes the identity component 222 and the authenticity component 220) in order for the content component 224 to be visible or detectable by an optical sensor/optical device (e.g., optical sensor/optical device of a scan device, optical sensor/optical device of a user device or device 102A-N as shown in the example of FIG. 1 and/or a device 402 of the example of FIG. 4A). The vertical range of the content component 224 can be a few centimeters away as long as it does not cast shadows that block a point source of light (e.g., source of light from optical sensor/optical device of a scan device, optical sensor/optical device of a user device or device 102A-N as shown in the example of FIG. 1 and/or a device 402 of the example of FIG. 4A) from reflecting diffraction patterns off the identity component 222 and the authenticity component 220.

Lateral positioning:
Since the diffractive pattern manufacturing process can produce multiple superimposed diffractive images on the tag 218, the identity component 222 and the authenticity component 220 can be laterally positioned to:
Overlap one another
Place one within the other.
Place one separate from the other without overlap. The lateral range between the identity component's 222 centroid and the authenticity component's 220 centroid are configured, defined, positioned, or oriented such that the reflective diffraction intensity of the identity component 222 and the authenticity component 220 are measurable at the same time using the same point light source (e.g., source of light from optical sensor/optical device of a scan device, optical sensor/optical device of a user device or device 102A-N as shown in the example of FIG. 1 and/or a device 402 of the example of FIG. 4A) to produce reflective-diffraction.

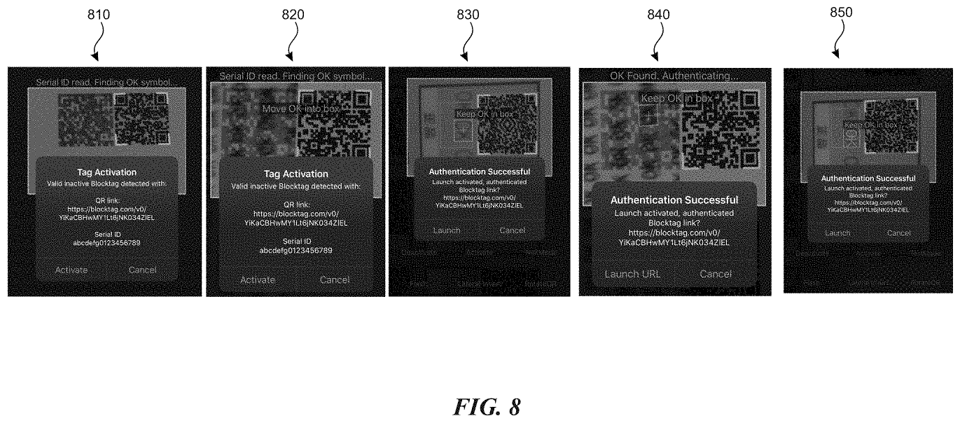

In one example, the horizontal span can range from zero up to a few centimeters away given the flash intensity of mobile devices like the iPhone 11 Pro used as a scan device/imaging device (a scan device, optical sensor/optical device of a user device or device 102A-N as shown in the example of FIG. 1 and/or a device 402 of the example of FIG. 4A). The optical lens array utilized can be preconfigured or predetermined (e.g., a microlens array having a Black OK symbol as shown in the examples of FIG. 8). The symbol layer of the optical lens array can also be defined to have specific characteristics. For example,

1. Shape:
implement any freeform shape that can be quantified distinctly (e.g., Hu Moments, a set of 7 numbers) and encoded into a color barcode or QR. For example, a Blocktag client's brand logo can be designed as the microlens symbol for tag branding purposes.

2. Spatial Frequency (Pattern):
Repeat a microlens symbol to create a recurring microlens pattern with a distinct spatial frequency that is different from the spatial frequency of a color barcode's halftone. For example, one microlens pattern is a set of equally spaced black vertical lines where the line is the basic microlens symbol, and the color barcode's halftone pattern is a set of equally spaced horizontal lines. Users may find it easier to use a scan device to authenticate by spatial frequency of a microlens symbol pattern than by movement of a microlens symbol. Occlusions on the microlens like (e.g., Dirt, reflected light, shadows, wear and tear) does not interfere with the spatial frequency signal of the symbol pattern, but can interfere with the shape of the microlens. 1

The foreground microlens symbol pattern and background color barcode halftone pattern can be designed such that the superposition of these two patterns produces new spatial frequencies (Moire patterns). These pre-calculated emergent spatial frequencies can be encoded as metadata into the color barcode. During authentication, a scan device can decode this baseline emergent spatial frequency and compare it with the actual emergent spatial frequency measured during authentication. The emergent spatial frequencies can be used as an even more secure way to bind the microlens authenticity component with the color barcode identity component, in case a bad actor physically separates the microlens from the color barcode, such as erasing the color barcode from the back of the microlens and printing counterfeit color barcode behind the microlens instead.

3. Color:
The foreground microlens symbol color can be designed to complement the background color barcode such that the superposition of these two colors produces new emergent color of shape/pattern. For example, if the foreground translucent microlens symbol is colored cyan and the underlying background barcode is colored yellow, the emergent microlens symbol color will appear green.

4. Animation
Animated differences in the perceived depth of the scan device from the surface of a microlens are generally large enough to be measurable by a stereoscopic camera.

FIG. 2C depicts an image of an example of a security device 230 printed as a blank tag with micro-optics and a blank printable area, in accordance with embodiments of the present disclosure.

Here the Yin Yang and Lock shapes and orientations are the symbols, the colors are created with pigment or identifiable ink or dye. The translucent polygons represent different types of micro-optical effects (different types of lenses or diffractives etc.). Even with these features, this combination can generate a large number of variations. In fact there can be more features—such as each lens type having a particular orientation in three-dimensions. The optical behavior of an authenticity component can depend on the pattern and arrangement of the micro-optical array(s) and image array(s). For example, a movement effect, rotation effect, float above the surface effect, sink below the surface effect, shape distortion effect, hide or opacity effect, reverse-parallax effect, and other optical effects can be arranged in a pattern. The particular parameters of each of these optical effects defines the micro-optical array layer(s).

On separate image layer(s) of the micro optical array of the authenticity component, various pigments or other substances can be applied to generate the shapes, orientations, and colorings. The pattern of the micro-optical features (lenses, transmissive-diffraction, etc.) is one layer of serialization For example, all Blocktags from the same master copy can include the same pattern of micro-optical features. An image layer is one of the layers in the micro-optical array (e.g., microlens). Specifically, the images or symbols are imprinted at the base of layer. A microlens image and a microlens symbol refer to the same thing (e.g., the OK symbol as shown in the example of FIG. 8). A security surface refers to the topmost microlens array layer. Different optical behaviors of the microlens array layer can be produced by designing different refractive or diffractive lenses on the topmost microlens array layer. Diffractive strips/confetti and different colored pigment/ink/dyes can be inserted into a color layer in the micro-optical array. The color layer can envelops each image at the base of the image layer.

The pattern of symbols and colorings represents another layer of serialization—for each particular tag. The colorings don't have to be visible spectrum colorings and they don't have to be optical—for example each color could represent a specific visual color or it could be a magnetic field strength, or it could be another electro-magnetic or optical property (e.g. fluorescent ink, infrared ink, magnetic ink, phosphorescent ink, or color shifting ink) that can be written above or below the micro-optical feature array layer. In general, the images can be any image or shape. Placing a 3D dot under the tag which warps the microlens symbol and movement can also increase entropy. The orientations of images may be in 2 dimensions or in 3 dimensions. In the layers of a microlens array, different images of different colors can be appended as new layers at the bottom of the micro-optical array. Each image+color layer can be staggered so that a color image from one layer does not block the color image from another layer when viewed from the top of the micro-optical array. Different micro-optical effects can be appended as new microlens array layers and also staggered to align with the target image layer at the bottom.

There is another way to achieve different micro-optical effects with different images (symbols) and colors without multiple image/color/microlens array layers. For example, to create an image/color/microlens array layer to have more than one image/color/microlens form factor.

FIG. 2D depicts an image of an example a security device 240 where an identity component includes a QR code 242, in accordance with embodiments of the present disclosure. The diffractive optical security surface 244 of the security device 240 can refer to transmissive diffraction from using special lenses on the topmost microlens array layer, or inserting reflective diffraction strips/confetti into the microlens array color layer, in accordance with embodiments of the present disclosure. FIG. 2E depicts an image of a further example a security device 250 where an identity component includes a QR code 252 and a reflective diffraction surface as diffractive pattern B 254, in accordance with embodiments of the present disclosure. FIG. 2F-FIG. 2P depict further examples of security devices, in accordance with embodiments of the present disclosure.

### Security Device Authentication

Embodiments of the present disclosure include systems and methods for authenticating a security device (e.g., which may also referred to herein as an ‘authentication device,’ a ‘tag,’ ‘Blocktag’ or a ‘Blocktag Device’). In one embodiment, the system (e.g., the host server 100 of FIG. 1 and/or the host server 300 of FIG. 3A-3B and/or the device 102A-N as shown in the example of FIG. 1 and/or the device 402 of the example of FIG. 4A) includes software modules and/or hardware components that can track, measure, detect, characterize and/or otherwise determine changes to optical properties of a security device (e.g., a tag, a “Blocktag”, the security device 108A-N as shown in the example of FIG. 1 or security devices as shown in the examples of FIG. 2A-FIG. 2P), across sequential frames of images of the security device, to determine if the security device is authentic. The security device can include components such as a lens array, a microlens array, a nano-lens array, a 2D or 3D lens array, a lenticular lens, a lenticular lens array, or a diffractive surface.

The authenticity of the security device (for example, comprised of at least one lens positioned above at least one visual image on a surface of the security device, or an array of such) can be determined or proved (e.g., by the authentication and verification engine 310 of the host server 300) using any optical sensor (e.g., an optical sensor/optical device of a scan device, optical sensor/optical device of a user device or device 102A-N as shown in the example of FIG. 1 and/or a device 402 of the example of FIG. 4A) to capture a set of at least two (or more) sequential images of the security device. The angle between the sensor and the security device surface can be different in each of the sequential images. The system can analyze the two or more sequential images (e.g., by an image analysis engine 314) to detect and measure differences in the optical characteristics and/or visual features (e.g., by an optical characteristics and position analyzer 312) or ‘Properties’ between each of the sequential images.

The system (e.g., the host server 100 of FIG. 1 and/or the host server 300 of FIG. 3A-3B and/or the device 102A-N as shown in the example of FIG. 1 and/or the device 402 of the example of FIG. 4A) can then determine whether the detected differences in Properties of two or more sequential images match or do not match valid changes in Properties. In general, the set of valid or invalid changes in Properties can be defined by a model. For example, the model can specify the horizontal/vertical planar distance (e.g. in millimeters) moved by a microlens symbol in the tag's 2D plane per unit change in the phone's pitch/row/yaw (in degrees) relative to the tag or per unit change in the phone's x/y/z position relative to the tag in 3D coordinate space.

In one embodiment, this model can be defined or specified, for example by performing one or more of:
Mathematically using a the microlens' curvature angle and glass substrate refractive index for calculation.
Empirically determining, measuring or calculating the horizontal (vertical) planar distance moved by the tag in the tag's plane per unit degree change in the phone's pitch (row) or x-axis (y-axis) movement relative to the tag.
Using intelligent learning algorithms to generalize the relationship between input delta rotation (pitch/row/yaw) and translation (x/y/z) and output delta horizontal/vertical planar distance.

The differences in Properties related to microlens as an optical sensor (e.g., as in a phone camera) moves in 3D space relative to the tag can for instance include, one or more of:
The horizontal/vertical planar distance (e.g., delta-x and delta-y) moved by a microlens symbol in a Blocktag's 2D plane from one video frame to another,
Changes in shape of a microlens symbol as it appears/disappears or changes from one symbol shape to another depending on the position of the camera phone relative to the tag,
Changes in the perceived depth of the microlens symbol under the surface of the tag, 1

Changes in spatial frequency of a periodic pattern formed by repeating the same symbol on the microlens area, and/or
Changes in spatial frequency due to the superposition of two or more periodic patterns.

The differences in Properties related to diffractives as a phone camera with flash turned on moves relative to the tag can for instance include, one or more of:
Changes in color and/or spectral properties of the diffractive surface,
Changes in spatial frequency of a periodic pattern due to reflective diffraction of the phone's point light source by the diffractive surface and/or
Changes in spatial frequency due to the superposition of two or more periodic patterns on the diffractive surface.

The differences can be generated from illumination by one type of light versus another type of light (such as with or without a flash on, or with or without filtering for specific wavelengths of light).

The system (e.g., the host server 100 of FIG. 1 and/or the host server 300 of FIG. 3A-3B and/or the device 102A-N as shown in the example of FIG. 1 and/or the device 402 of the example of FIG. 4A) can determine or provide the authenticity of a Blocktag, for example, using smartphone, optical sensor, electronic sensor, or computer hardware device (e.g., an optical sensor/optical device of a scan device, optical sensor/optical device of a user device or device 102A-N as shown in the example of FIG. 1 and/or a device 402 of the example of FIG. 4A).

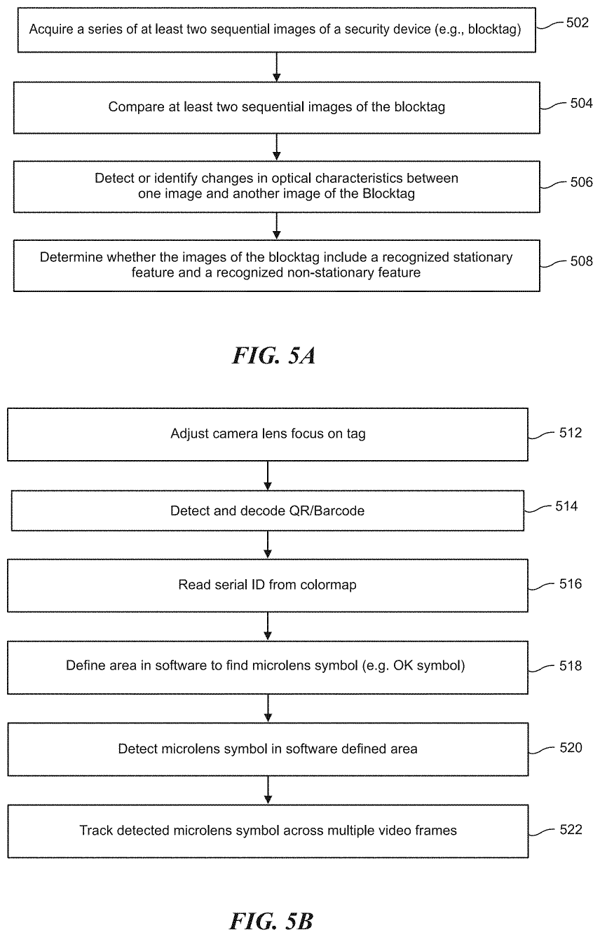

In one embodiment, the authenticity of a Blocktag can determined by acquiring a series of at least two sequential images of a Blocktag and comparing the at least two sequential images (e.g., image analysis engine 414 of the mobile device 402 and/or image analysis engine 314 of the host server 300) to detect changes in optical characteristics between one image and another image of the Blocktag. For example, it can then be determined whether the images of the Blocktag include at least one recognized stationary feature and one recognized non-stationary feature (e.g., by a feature extractor and detector 415 of the mobile device 402 and/or a feature extractor and detector 315 of the host server 300). If no recognized feature is detected in at least two sequential images, the system can acquire more sequential images of the Blocktag until a specified number of images are found in sequence where each image includes the recognized features. In other words, if no feature is detected go the process is repeated until it is detected, as shown in the example process flow of FIG. 5A.

In a further embodiment the differences between changing optical characteristics of images and/or recognized features of a Blocktag are tracked, calculated, analyzed, measured or otherwise determined from, a sequence of images of a Blocktag(e.g., by an optical characteristics and position analyzer 412 of the mobile device 402 and/or the optical characteristics and position analyzer 312 of the host server 300). The determination of the changing optical characteristics are performed to determine the degree to which they fit a mathematical model. For example, a model can be created, devised, or generated using an intelligent learning algorithm that has been trained on authentic and inauthentic Blocktags of the potential differences in optical characteristics of a Blocktag. The differences in optical characteristics can include, for example, a difference in delta-x and delta-y and/or delta z between one or more images appearing in sequential frames of images of a Blocktag. The difference can also include one or more of orientation, shape or color or contrast, or spectral properties of visual elements or scattered light, in sequential images of a Blocktag.

The difference can be that changes to images, or different images, appear in sequential frames of images of a Blocktag or where the difference is between characteristics which appear under illumination by different types of light or light with different optical properties (such as with or without a flash on, or with or without filtering for specific wavelengths of light). The difference can also appear when light is reflected or refracted from the surface from at least two different angles, in sequential images of a Blocktag. If the Blocktag is determined or proved to be authentic (e.g., by the authentication and verification engine 310 of the host server 300 and/or an authentication and verification engine 412 of the mobile device 402), additional actions can be triggered to occur. If the Blocktag cannot determined be determined to be authentic or is proved to be inauthentic, a different set of actions can be triggered to occur. Examples of such actions can include launching a URL, sending a message, initiating a transaction, prompting a person or software agent to make a decision, showing content to a person, changing data in a database, etc.

In one embodiment, a Blocktag is authenticated by analyzing, tracking, computing and/or determining changes in position between at least one stationary feature on the surface and at least one non-stationary feature on the surface (e.g., by an optical characteristics and position analyzer 412 of the mobile device 402 and/or the optical characteristics and position analyzer 312 of the host server 300). For example, the analysis can determine or measure the change in relationship of at least one stationary feature and at least one non-stationary feature on the surface, as the surface is moved relative to a sensor (e.g., an optical sensor/optical device of a scan device, optical sensor/optical device of a user device or device 102A-N as shown in the example of FIG. 1 and/or a device 402 of the example of FIG. 4A) and/or where the sensor is moved relative to a surface of the security device. The non-stationary feature can be generated by one or more refractive lenses, a micro-lens array or a 3D lens array positioned above one or more visual images. As the surface is moved or as a sensor is moved, the change in relative position causes light to be refracted at different angles through the lenses and creates the appearance of a non-stationary (moving) image(s).

The system (e.g., the host server 100 of FIG. 1 and/or the host server 300 of FIG. 3A-3B and/or the device 102A-N as shown in the example of FIG. 1 and/or the device 402 of the example of FIG. 4A) can track, analyze, determine or measure change in the vertical delta and horizontal delta between the stationary features and non-stationary features over time, as the security surface/security device and/or the sensor are moved or otherwise change in relative position to one another. The system can further implement computer vision and/or intelligent learning algorithms to automatically detect at least one stationary feature and/or at least one non-stationary feature on the surface. Examples of a stationary feature on the surface can include, for instance, a visible identifier such as a bar code, QR code, block code, logo or icon, or illustration, serial number, visual marker or pattern, reticle or target, or encrypted ID or pattern. Examples of a non-stationary feature can include an optical diffractive surface (such as a hologram or nano-etched diffractive) or refractive lens (such as a microlens or 3D lens). The microlens or 3D lens can generally include multiple sub-lenses that refract images printed on a surface below them or within the material, such that the images are refracted and appear to change position when the surface and/or sensor are moved relative to one another). The system can, in some embodiments, also detect and authenticate additional overtly visible and/or covert hidden features (e.g., by the feature extractor and detector 415 of the mobile device 402 and/or the feature extractor and detector 315 of the host server 300) that can also be part of the stationary or non-stationary features of the surface and surrounding materials. For example, seemingly random defects or aberrations in the diffractive or refractive surfaces or surrounding material, microscopic dots or codes can be visible to and detectable by a sensor.

For example, special reflective materials that reflect only specific wavelengths of light, hidden spectral signatures and/or spectrum shifts that occur when the surfaces are moved and that are encoded into the diffractive or refractive surfaces that can be detected and analyzed by a sensor (e.g., an optical sensor/optical device of a scan device, optical sensor/optical device of a user device or device 102A-N as shown in the example of FIG. 1 and/or a device 402 of the example of FIG. 4A). Optical properties that are not visible to eye can be detected by IR or UV sensors. Additionally, physical or geometric properties of the surface or any surrounding material or object such as the shape, texture of the surface or grain or material of the surface can be detected by the sensor.

In general, the security device can include or be affixed to or otherwise associated with for example, a label, tag, sticker, badge, certificate, logo, artwork, hangtag, brand protection device, anti-theft tag, anti-counterfeiting tag, RFID tag, serial number, serialization code, NFC tag, bar code, QR code, authenticity hologram, product ID badge, identity badge or identity document, warranty, deed or title, certificate of authenticity, tamper-proof seal, product packaging, tamper proof seal, adhesive tape, adhesive material, textile, certificate, stamp, signature, brand identity, printed or etched surface. The security device can be added to a product during manufacture, or added to the product after it is manufactured, or part of a product package when the package is manufactured, or added to the package after the package is manufactured.

An alternative embodiment includes authenticating a surface or tag by analyzing changes in position between at least two non-stationary features on the surface or tag (e.g., by the optical characteristics and position analyzer 412 of the mobile device 402 and/or the optical characteristics and position analyzer 312 of the host server 300). Some tags can have two non-stationary features. For example, a tag can include two different micro-lenses side by side, where one is the serialized code and one is not. The system can detect and determine look how they both move at once relative to each other). The system can analyze and determines the change in relationship of at least two non-stationary features, as the surface is moved relative to a sensor (such as a camera or laser or other optical sensor), and/or where the sensor is moved relative to the surface of the security device. In one embodiment, the vertical delta and horizontal delta between at least two non-stationary features can be tracked and measured over time, as the surface and/or the sensor are moved relative to one another. Computer vision and/or intelligent learning algorithms can be implemented to automatically detect at least one non-stationary feature. computer vision and/or intelligent learning algorithms can also be used to automatically authenticate at least one non-stationary feature on the surface/tag.

The non-stationary features on the surface of the security device can include a visible identifier such as a bar code, QR code, block code, logo or icon, or illustration, serial number, visual marker or pattern, reticle or target, or encrypted ID or pattern. The non-stationary features can also include an optical diffractive surface (such as a hologram or nano-etched diffractive) or refractive lens (such as a microlens or 3D lens having multiple sub-lenses that refract images printed on a surface below them or within the material, such that the images are refracted and appear to change position when the surface and/or sensor are moved relative to one another).

The system can also optionally detect and authenticate additional overtly visible and/or covert hidden features that may also be part of the non-stationary features of the surface and surrounding materials. For example seemingly random defects or aberrations in the diffractive or refractive surfaces or surrounding material, or microscopic dots or codes that are visible to a sensor, special reflective materials that reflect only specific wavelengths of light, hidden spectral signatures and/or spectrum shifts that occur when the surfaces are moved and that are encoded into the diffractive or refractive surfaces that can be detected and analyzed (e.g., by the optical characteristics and position analyzer 412 of the mobile device 402 and/or the optical characteristics and position analyzer 312 of the host server 300), or optical properties that are not visible to eye but may be detected by IR or UV sensors, or physical or geometric properties of the surface or any surrounding material or object such as the shape or texture or grain or material the surface of the security device.

One embodiment includes authenticating a security device by analyzing changes in optical properties of at least one feature on a surface of the security device (e.g., by the optical characteristics and position analyzer 412 of the mobile device 402 and/or the optical characteristics and position analyzer 312 of the host server 300) as the security device is moved relative to a sensor (such as a camera or laser or other optical sensor), and/or where the sensor is moved relative to the surface or tag. The analysis can utilize computer vision and/or intelligent learning algorithms to automatically detect at least one optical property or at least one change to at least one optical property. Computer vision and/or intelligent learning algorithms can also be used to automatically authenticate at least one optical property, such as a spectrum signature or spectrum shift due to change in angles between a surface and a sensor. In general, at least one stationary feature on the surface can include a visible identifier such as a bar code, QR code, block code, logo or icon, or illustration, serial number, visual marker or pattern, reticle or target, or encrypted ID or pattern. The at least one non-stationary feature may include an optical diffractive surface (such as a hologram or nano-etched diffractive) or refractive lens (such as a microlens or 3D lens containing up to many sub-lenses that refract images printed on a surface below them or within the material, such that the images are refracted and appear to change position when the surface and/or sensor are moved relative to one another).

The system can also detect and authenticate additional overtly visible and/or covert hidden features that may also be part of the stationary or non-stationary features of the surface and surrounding materials. For example seemingly random defects or aberrations in the diffractive or refractive surfaces or surrounding material, or microscopic dots or codes that are visible to a sensor, special reflective materials that reflect only specific wavelengths of light, hidden spectral signatures and/or spectrum shifts that occur when the surfaces are moved and that are encoded into the diffractive or refractive surfaces that can be detected and analyzed by a sensor, or optical properties that are not visible to eye but may be detected by IR or UV sensors, or physical or geometric properties of the surface or any surrounding material or object such as the shape or texture or grain or material the surface.

Further embodiment of a process to authenticating a security device is described as follows:

Instead of measuring the delta in geometric relationships between one or more elements of a Blocktag (such as a stationary and non-stationary element on a surface) when the security device and/or a sensor are moved relative to one another, the system can measure a change in the state of a surface when it is illuminated by natural light versus light from a camera flash bulb (e.g., a source of light from optical sensor/optical device of a scan device, optical sensor/optical device of a user device or device 102A-N as shown in the example of FIG. 1 and/or a device 402 of the example of FIG. 4A).

The flash bulb is in a slightly different location on the camera from the camera lens. When the flash is off, scattered light from the environment reflects off the surface to the camera lens, causing image A to appear. When the flash is on, light from a different angle (the location of the flash bulb) reflects back to the camera, causing image B to appear. Image B may simply be a shifted version of A, or it could be a different image reflected from a different set of lenses at a different x-y or x-y-z orientation inside the refractive material.

The system can also include lenses or images behind lenses that reflect ordinary light differently than the light from a camera flash, causing a different image, or multiple after images, ghost images, internal reflected images, or very different contrast or color to appear. In one embodiment. the particular behavior (optical behavior) of a particular refractive material under non-flash illumination and flash-illuminated can be characterized or learned, so it can then be detected. In this case the system can perform a process or analysis to detect a delta between lighting condition A and lighting condition B, where only one is illuminated by the flash bulb, such that the surface of the security device can be authenticated. This process enables rapid authentication without any movement of the camera and/or the tag.

Instead for example, the surface can be imaged in the camera using special software of the disclosed technology and then the flash is triggered one or more times and the image(s) under flash illumination is also detected and compared to the non-flash image(s). This enables very rapid detection and authentication without requiring fine motor control or precise movement on the part of the user holding the device with the camera or sensor.

Further embodiment of a process for authenticating a security device is described as follows:

In cases where environment lighting variations are challenging (e.g. Multiple other point sources of light that adds noise to diffraction signal from the camera's point light source, or dark environments which makes it hard to detect microlens/diffractive surface features), authentication can be determined by measuring changes in the frequency of a Blocktag element's periodic pattern when the surface and/or sensor are moved relative to one another. For example, a line grating pattern on a transparent microlens array or an opaque, diffractive surface that appears/disappears depending on how the sensor moves relative to the surface.

Moreover, when two or more periodic patterns, each with their unique frequency characteristic, are superimposed together, the composite frequency characteristics that emerge can also be measured. The superposition can happen between for example:
One or more periodic patterns designed into an opaque diffractive surface
One or more periodic patterns designed into a transparent microlens layer,
One periodic pattern printed behind a transparent microlens layer with one or more periodic patterns designed into a transparent microlens layer.

Therefore, the system (e.g., the host server 100 of FIG. 1 and/or the host server 300 of FIG. 3A-3B and/or the device 102A-N as shown in the example of FIG. 1 and/or the device 402 of the example of FIG. 4A) can utilize computer vision or intelligent learning algorithms to automatically detect spatial frequency information belonging to one or more periodic patterns on the tag. One embodiment of the present disclosure includes Authentication with attestation by an arbitrary entity (e.g., entity 114 of the example of FIG. 1). A security device may prove the identity of an entity (the “prover”) that certified its authentication. Using a part of the tag for serialization, such as a 1d/2d/3d barcode, chaosmetric elements, overt and covert features, and any combinations of the above, printed on the same area as the authentication area (e.g. a 2d colored barcode printed behind a transparent microlens array) a tag can prove unique identity.

The private key of the prover is then used to sign a hash of some or all of these serialization features, and can be represented on the tag as a 1d/2d/3d barcode or other visual data encoding. Some or part of the serialization features may be omitted from the signature, and some or part of the serialization features may be stored in a database or blockchain for future comparison. The visual data encoding may contain only a fragment of the signature data. The signature can be verified using the serialization features and the public key of the prover. There can be further verification by cross checking serialization features with the data stored in a database (e.g., a security device repository 322 and/or a tag identity/property repository 324 of FIG. 3A and/or the security device repository 122 and/or the tag identity/property repository 124 of FIG. 1).

creation: sign(hash(printed serial+chaosmetric elements+overt/covert features) with prover's private key)⇒printed and stored signature/signature fragments

Verification: decrypt(signature with prover's public key)⇒confirm that it is equal to hash(printed serial+chaosmetric elements+overt/covert features)

Authentication with attestation by an arbitrary entity (e.g., entity 114 of the example of FIG. 1) allows 3rd parties (e.g., entity 112 of the example of FIG. 1) to prove they were the ones who generated the tag or the tag data, using their private/public key pairs. It is the responsibility of the 3rd parties (e.g., entity 112 of the example of FIG. 1) to ensure their tags have enough entropy such that the identities of the tags are unique. If a tag is found to be not unique, the reputation score of the attesting entity can be affected. The tag features used to derive a unique and anti-counterfeitable identity can be selected freely by the attesting entity. Market effects (e.g., demand reduction for counterfeitable and non-unique tags) is used to self-regulate the system. Tags that comply with this interface, including the attestation, and the unique tag identity, can be interoperable despite differences in manufacturer, anti-counterfeit technology, track record, and other properties.

A shared database (and/or blockchain) (e.g., the security device repository 322 and/or the tag identity/property repository 324 and/or the ledger address repository of FIG. 3A and/or the security device repository 122 and/or the tag identity/property repository 124 and/or the ledger address repository 126 and/or the scan log and authentication challenge repository 128 of FIG. 1) can be a bridge for all the different type of tags, where identity and tag properties are stored. This enables integration with 3rd party (e.g., entity 112 of the example of FIG. 1) legacy tag systems. Multiple 3rd party legacy tag systems can communicate with each other using around scenarios related to the tag using the tag's serial ID and its attesting entity.

One embodiment of the present disclosure includes offline authentication without connecting to a wired/wireless network. Besides using part of the tag for serialization to prove unique identity (e.g. a serial ID encoded onto a 1d/2d/3d barcode, the identity component), additional metadata related to authentication parameters such as the known baseline position/velocity/acceleration of microlens symbol or characteristics of a diffractive surface can also be encoded on a Blocktag as a 1d/2d/3d barcode. The encoded metadata can be decoded by the local scanning device (e.g., an optical sensor/optical device of a scan device, optical sensor/optical device of a user device or device 102A-N as shown in the example of FIG. 1 and/or a device 402 of the example of FIG. 4A) without connecting to a remote server (e.g., the host server 100 of FIG. 1 and/or the host server 300 of FIG. 3A-3B) when there is no wired or wireless network connection, or when network download/upload speeds are slow. For example, locations lacking IT infrastructure such as underground, underwater or off-Earth locations (e.g. asteroids, moons, other planets) when using Blocktags to mark stakes to claims of land or natural resources, including land ownership claims and mining claims

### Additional Authentication Mechanisms:

In a further embodiment, the system (e.g., the host server 100 of FIG. 1 and/or the host server 300 of FIG. 3A-3B and/or the device 102A-N as shown in the example of FIG. 1 and/or the device 402 of the example of FIG. 4A) performs a process for authenticating the microlens layer pattern. Each microlens has manufacturing inconsistencies such as different angles, reflective patterns, offset, colors, and response to viewer movement. These inconsistencies can otherwise be characterized as unique properties, and can be recorded and hashed. When the microlens is scanned at a future time, these characteristics may be input into the same hashing algorithm, which can then be cross-checked with the recorded hash to verify whether it is the same exact microlens. The system can perform a process for authenticating the image layer pattern. The image layer pattern (e.g., 1d/2d/3d barcode) is matched to the unique properties of each microlens, thus disabling any Blocktag that has been partially tampered with. e.g., a Blocktag with a replaced QR code would not be verified.

The system can also perform a process for Authenticating how the image layer pattern moves due to the microlens layer. In addition, the microlens layer may be coated (above and/or below) with stationary or holographic/dynamic chaosmetric patterns, which allow for a greater addressable space for serialization This chaosmetric pattern can then be cross referenced with the QR code and the unique microlens characteristics on the same tag. In one embodiment, the system can perform an authentication process to prove that a person is in close proximity and within line of sight of an item tagged with a Blocktag (Proof of Presence) (e.g., by the proof of presence/possession/title engine 318 of the host server 300). In addition, the system can perform an authentication process to prove that the person has physical control of the aforementioned Blocktag (Proof of Possession) (e.g., by the proof of presence/possession/title engine 318 of the host server 300).

The Blocktag/security device can include, for example, an authenticity, identity and content component that can be attached to a physical good as a sticker. The authenticity component can include microlens arrays or nanodiffractives. The authenticity component can be uniquely identified and tamper-proofed by physically printing the identity component (e.g. A color barcode) on the back of a transparent microlens array. The authenticity component can also be uniquely identified and tamper-proofed by printing the identity component on paper and affixing the microlens array on top so that a scan device can detect the microlens symbol when flash is off and decode the color barcode' serial ID when flash is on.

In one embodiment the authenticity component can also be attached to the identity component algorithmically. For example, the identity component's serial ID is generated by serializing overt/covert authentication parameters that identify or quantify a microlens array's optical effect. This also has the benefit of isolating the impact of hack attempts to only a small subset of Blocktags that were cut from the same microlens array sheet. For example, the identity component can include a halftone pattern and the authenticity component may be designed to include a spatial pattern. The superposition of these two patterns produces expected, emergent patterns that may be used as the authentication signal.

In one embodiment, the system includes a device (e.g., a mobile device, a scan device/scanning device) to perform a process to perform Proof of Presence determination by imaging or scanning a Blocktag in a single time instance (e.g. A single video frame). The system can also prove or perform authentication for Proof of Possession by scanning a Blocktag in across multiple time instances (e.g. Multiple video frames). The system (e.g., the host server 100 of FIG. 1 and/or the host server 300 of FIG. 3A-3B and/or the device 102A-N as shown in the example of FIG. 1 and/or the device 402 of the example of FIG. 4A) can for example, determine, compute or quantify a Blocktag microlens array symbol's position relative to a fixed point on the tag's 2D plane as a function of the device's rotation (pitch, roll, yaw) and/or translation (horizontal, vertical, depth) relative to the tag. The system can also compute or quantify a Blocktag microlens array symbol's Velocity (Acceleration), the rate of change of the symbol's position (velocity) measured by the scanning device from a previous video frame to a current frame, as a function of the change in one or more of the 6 degrees of freedom (pitch, roll, yaw, left, right, up, down forward, backward) between the scanning device and tag.

In a further embodiment, the system can perform a process including a challenge-response protocol on a device that challenges the participant to respond by orienting the scanning device relative to the tag to meet one or more requirements in the six degrees of freedom (pitch, roll, yaw, left, right, up, down forward, backward) per challenge-response instance and across multiple instances in time. In one example, a user interface on the scanning device utilizes an augmented reality environment (e.g., deployed by the AR engine 350 of the host server of FIG. 3A) to facilitate the authentication process between the challenge-response protocol and a participant.

One further embodiment of the system includes integration of a security device's (Blocktag's) Proof of Presence and Proof of Possession authentication with 3rd party (e.g., third party tag generator entity 112 of the example of FIG. 1) legacy track-and-trace tag systems. The security device can include, for example, at least three components: (1) an authenticity component, (2) an identity component, and (3) a content component. For example, the authenticity and identity component can be manufactured by a 1st party (e.g., Blocktag Manufacturer, the host entity which hosts or administers the host server 100 of FIG. 1 and/or the host server 300 of FIG. 3A-3B) and the content component can be a 3rd party (e.g., third party tag generator entity 112 of the example of FIG. 1, Blocktag Customer) legacy QR system.

For example, the authenticity and/or the identity component can be adhered in a vicinity of or adjacent to, or otherwise associated with a pre-existing 3rd party legacy QR on a product's packaging. The security device or tag having an authenticity (1st party), identity (1st party) and/or content (3rd party) component can be scanned. In addition, the tags can be scanned in bulk. The scanned authenticity, identity and content components as a unique combination can be registered as being associated with the tag. The Blocktag with three components solves the problem of: Integration with legacy systems of QR printed on packaging, integration with current payment gateways in Point Of Sale (POS) scenarios. The block tag also bridges the disconnect between a merchant's supply chain tracking system and what happens on the demand side post-sales after customer buys product off the shelf. In one embodiment, the system can perform processes to perform Proof of Presence and Proof of Possession authentication offline without connecting to a wired/wireless network. A tag's microlens array area can be uniquely identified by printing and superimposing encoded metadata over the microlens array. The encoded metadata can include for example A serial identifier and/or Challenge-response parameters for proof of possession such as the known baseline position/velocity/acceleration of microlens symbol. The system can also decode the encoded metadata using a local scanning device. Note that one or more features of a Blocktag are serialized (e.g., by the security device tracking engine 310 or the serial ID generator 342 of the host server 300) to uniquely identify the tag. The precise alignment and relative positions of the stationary and non-stationary (micro-optical) features of a Blocktag encode overt or covert security features, including authenticity and/or serialization

The disclosed system can include a mobile application on a mobile phone (e.g. a device 102A-N as shown in the example of FIG. 1 and/or a device 402 of the example of FIG. 4A) equipped with a camera functions can be used the sensor for detecting and/or authenticating a Blocktag. In general, an optical sensor (e.g., an optical sensor/optical device of a scan device, optical sensor/optical device of a user device or device 102A-N as shown in the example of FIG. 1 and/or a device 402 of the example of FIG. 4A) such as a laser and laser sensor, an LED/LED sensor, or a CCD camera, can function as the sensor for detecting and/or authenticating a Blocktag.

At the time of a Blocktag scan event, during which a Blocktag is authenticated by a sensor on a device such as a mobile phone, additional data (such as telemetry and data about the device and the app and user of the device, including location information, identity information, aggregate demographic information or device information, application state information, location specific contextual information, user intent information, or product information) can be gathered from the device at the time of scan and sent to be logged or used by a local or remote database or software application (e.g., the security device repository 322 and/or the tag identity/property repository 324 and/or the ledger address repository of FIG. 3A and/or the security device repository 122 and/or the tag identity/property repository 124 and/or the ledger address repository 126 and/or the scan log and authentication challenge repository 128 of FIG. 1, and/or the scan log and authentication challenge repository 428 of FIG. 4A), which may include or utilize a distributed ledger such as a blockchain

Furthermore, at the time of a Blocktag scan event, additional information can be presented to the user of a device on which the scan event occurs, where this information may include advertising, special offers, coupons, gifts, loyalty rewards or points, surveys or polls, interactive challenges or games, product information, warranty information, product provenance information, pricing or sale information, or personalized content or targeted messages.

A user can initiate a Blocktag scan event from software on their device (e.g. the device 102A-N as shown in the example of FIG. 1 and/or the device 402 of the example of FIG. 4A). The scan event can be directed to take place on the software on a remote server (e.g., the host server 100 of FIG. 1 and/or the host server 300 of FIG. 3A-3B). For example, Sue wants to buy a product from Bob over the Internet, but Sue first needs Bob to prove that he has the product in his possession and that the product is authentic. Sue uses software on her device to request that Bob uses software on his device to authenticate an authenticity tag on the product, where the method of authentication is as described above (e.g., where the tag is a surface containing one or more stationary and/or non-stationary features that are analyzed as the surface and/or sensor are moved relative to one another). When Bob's software authenticates the surface in response to the request from Sue, then Bob's software sends an encrypted and digitally signed response back to Sue's software with the result of the authentication challenge. In other words, Sue can remotely authenticate the authenticity tag on a product that Bob has at another location, over the Internet. This can be utilized to enable buyers to determine that sellers actually possess items they claim to possess and that the items are authentic. Example: User A requests that user B prove they have object K in their possession. User B proves it using the Blocktag app at their location. The Blocktag app certifies the result and transmits it security to the Blocktag app of User A. User A can optionally also watch in real-time or view a video recording of the authentication session from User B's device (with User B's permission).

In one embodiment, every Blocktag scan event and every authentication challenge can be stored in a new entry in a database (e.g., the scan log and authentication challenge repository 128 of FIG. 1, and/or the scan log and authentication challenge repository 428 of FIG. 4A). For instance, the database can include or be a distributed ledger such as a blockchain Each entry can log information about the serial number and identity of the tag/surface that was scanned and any product ID or SKU that it is associated with, as well as the location and result of the scan event, the identity of the user who initiated the scan, the type of device that initiated the scan, and/or the result of the scan (such as establishing an authenticity tag on the a product is authentic or not, or that it has been tampered with or not, or that it is the correct tag for a given product SKU or particular product). The authenticity of a serialized Blocktag can also be stored with information about the particular covert or overt physical features of a product or item such as the grain or texture or shape or spectral properties, hidden or covert features, special materials or geometric positioning of features on the product etc. In this manner the unique serialized tag can be associated with the unique features of a particular physical object and both can be stored together in a database, such that authenticity is only true if both are present in a particular configuration (for example when the tag was first added to a product it was photographed on the surface in a position relative to the features on the product or the material of the product itself, such that it will only be deemed to be authentic if it exactly matches the specific placement and features of the tag and the surface in that photo).

In some cases, a tag or label (or any surface used for authentication) may be inactive and can then be activated and can then be deactivated. The activation process registers a serialized tag as attached to a particular product (by the ID or SKU or serial number of the product, or other information or physical features of the product). In other words, activation is when the first user of a tag attests that the Blocktag has been attached to an object, and that object is as stated truthfully in the activation data. A tag may be activated using software on a mobile device or other computing device, system and/or sensor (e.g., the host server 100 of FIG. 1 and/or the host server 300 of FIG. 3A-3B and/or the device 102A-N as shown in the example of FIG. 1 and/or the device 402 of the example of FIG. 4A). Once activated (e.g., by the security device tracking engine 310 or the activation engine 344 of the host server 300) the tag may then be authenticated by other devices (e.g. the device 102A-N as shown in the example of FIG. 1 and/or the device 402 of the example of FIG. 4A) that have the software and information about the serialized tag and the product. In one example, a tag is first authenticated and then as a second step the serialization information of the tag (which may be in an encrypted or unencrypted serial number, or barcode or QR code, or in some other visual overt or covert feature of the tag) may then be authenticated as well, and then optionally the co-presence of the authentic tag, the authentic serialization code, and other features of the physical object may be tested in order to finally determine authenticity. It is also possible to authenticate a tag without also authenticating a serialization code on the tag and/or without authenticating specific physical features of an item the tag is on. However, it is stronger to authenticate all three together.

An authenticity test (a scan event) of a tag generates encrypted information that is compared to encrypted information in a database, which may be a blockchain, and where this process may also make use of public key cryptography techniques where one or more segments of encrypted information on a tag and/or in a database are signed with one or more private keys, and are then verified by one or more public keys, in order to determine whether the tag is authentic. A user is rewarded with loyalty points, or other rewards, for achieving certain scan event goals—such as for each scan, or for scanning a product a certain number of times or a number of times per unit time, or by scanning a product and then having another person scan a product in close proximity in time and/or physical space. One or more parties may enact a transaction or transfer of ownership of a physical thing (such as a product or a wallet or a collectible or unit of currency) and/or a digital thing (such as a token, data file, or digital object or application) by scanning an object that contains a surface that functions as an authenticity seal. In this process, the seller or transferor is the registered owner of the item in a database such as a blockchain The buyer or transferee scans the surface. This results in a lookup to determine an identity (which may be anonymous) of the seller or transferor, which in turn sends a message to the seller or transferor requesting their confirmation and permission to effect the transaction and/or transfer.

Alternatively, an ownership transfer request can be broadcast publicly (e.g.,. on a distributed ledger), which can then be retrieved and countersigned by the current owner. Once their permission is granted then the database is updated with a record of the transaction event and the identity of the new owner of the object. If an object is stolen however, the present owner can simply report it as such and/or refuse to approve a request of transfer. Only the party who is registered as the owner can transfer or use the object for transactions, so if an unauthorized party steals it they will be unable to use it for any further transactions because ownership was not transferred to them by the previous owner. For example Sue owns item X. She wants to sell or transfer it to Bob. She lets Bob scan X either in person, or remotely whereby Bob can initiate a scan request on Sue's device from his device. When Bob scans the authentication tag on X he then authenticates himself on his device in order to request a transfer. Sue receives the request and approves it. At that point Bob becomes the registered owner of X. Once a tag is authenticated it then launches further applications or information, such as a Web page, a dynamically served advertisement or offer, an application in a particular state, an API call, etc. The process of interacting with a tag has multiple steps, in which a first step recognizes a first element (such as QR code) in any application capable of recognizing it (such as any QR reader), and then takes the user to a Web page or application page that tests whether the user already has a specialized application installed, and if they do not have the application installed it prompts them to install it, and if they do have it installed it launches that application. Once that application launches it then further analyses the tag to detect and authenticate the relationship of at least two key elements of the tag (stationary and non-stationary, or stationary and stationary, for example) in order to authenticate the tag, at which point further operations may take place.

Or alternatively if the user already has the specialized application installed they can use that first recognize the first element (such as a QR code or bar code) and then optionally recognize a second element (such as a non-stationary lenticular or holographic or microlens image) and then authenticate the tag based on the attributes and relationships of the elements. Furthermore a user may be given the choice of whether to only recognize the first element, or to authenticate the tag by analyzing and authenticating it across multiple elements of the tag (such as one or more stationary or non-stationary elements). The information or application states that are triggered or launched when a user analyzes a tag in a specialized application are dependent on the user's role and access permissions (admin, read, write permissions). For example a user who is just a guest or customer sees consumer information about a tag, but a user who is a manufacturer or a distributor or retailer would see additional and/or different layers of information about the tag based on their roles. For example a manufacturer could see information about the manufacturing process of a product that the tag is attached to. A distributor could see information about the inventory and distribution of a product the tag is attached to. A retailer could see information about the inventory and sales statistics of a product the tag is attached to, or aggregate data and analytics across many products.

In some instances, embodiments of the present disclosure include a track and trace system. Track and trace system can be provided based on tracking items that are tagged as they move through a supply chain from manufacture to retail, and even post-retail to the customer and then to the aftermarket. In the track and trace system, analytics can be provided that can show permitted parties the entire or partial history and provenance of a tag, as well as analytics and trends about the cohort of products or the family of products, by region, type of customer, type of channel, particular channel, type of outlet, particular outlet, and so forth as products move through the supply chain and then to customers and to the aftermarket. The track and trace system can also show what happens to a product after retail such as how often consumers engage with the product, and when they buy and sell it in the aftermarket. A manufacturer or brand, or a buyer or seller, could see the provenance of a product in order to authenticate it, value it, and determine whether to buy or sell it.

In some instances, the refractive surface is not paired with a stationary element of any kind (such as a QR code or logo or serial number) at all—instead there is only a refractive surface having at least one non-stationary element. In this case, system components can still detect and authenticate how the non-stationary elements in the surface/tag move relative to the surrounding stationary material that the tag is placed on, or relative to the boundary or edges of the refractive tag itself

This process of authentication can enable users to authenticate something with a camera (for example on a mobile device or a sensor device) or other types of sensors (e.g., optical sensors such as a laser and a laser light sensor). The items that can be authenticated in this manner include currencies such as bank notes (for example national currencies), legal documents such as contracts or mortgages or legal agreements, securities such as stock certificates and bond certificates, deeds and title to property, signatures on any type of document, tax certification stamps, regulatory agency certification stamps, import/export certification stamps, notarization stamps or signatures, corporate seals, officer signatures, official government stamps, seals of approval, certificates or certifications of all kinds, licenses, admission tickets, automotive VIN numbers, coupons, credit cards, bank cards, debit cards, prepaid cards, gift cards, phone cards, bank checks, ID cards, passports, tourist visas, birth certificates, citizenship certificates, social security cards, corporate ID cards, membership cards, license plates, vehicle registrations, warranties, product registration cards, ownership certificates, valuation certificates, authenticity certificates, seals of approval, product packaging, legal notices, evidence packages, cosmetics, pharmaceuticals, luxury goods, tools, machinery, musical instruments, artworks and collectible objects, foods and beverages, textiles and fabrics, equipment, electronics and components, weapons and ammunition, footwear, medical devices and implants, computer equipment and components, audio or video media content, product packaging, shipping palettes, shipping containers, shelves or cabinet locations, inventory locations, digital storage devices, jewelry and fashion accessories, seats or tables or locations in a venue, sports equipment, groceries or items in a store, eyewear products, tobacco or cannabis packaging or deliver devices, physical locations or real-estate, plants, livestock, identity tags for humans such as on wristbands or wearables for use in tracking of people or admission to parks or events, inventory items, shipping containers and palettes, packages, inventory or stock locations, or other forms of tags such as RFID and NFC tags.

In one embodiment, tags (security devices) for a set of items can be aggregated (e.g., by the security device tracking engine 340 of the host server 300) under a tag for a package or container for that set of items, and then the tag for the container or set can be further aggregated with sets of other tags for other containers or sets into a higher level container or set. The tags can also be de-aggregated and re-aggregated (e.g., by the security device tracking engine 340 of the host server 300) from these sets as items are packed, shipped, unpacked, recombined and repacked, and reshipped, unpacked, stores, stocked, placed into retail locations, and sold etc. This can be used to enable the track and trace system (e.g., the security device tracking engine 340 of the host server 300) for tracking items, packages, palettes and shipments across a series of locations and participants in a supply chain Tags of this nature can be used to authenticate products that are received, sent, or returned to a distribution location, and/or to match products to packaging by matching tags on the product and package.

Tags can be tamper-proof or tamper-resistant such that if they are bent or torn or removed, the optical properties of the tag will be altered in a way that distorts the relative positions between the stationary and non-stationary elements, or between multiple non-stationary elements, such that the system (e.g., the host server 100 of FIG. 1 and/or the host server 300 of FIG. 3A-3B and/or the device 102A-N as shown in the example of FIG. 1 and/or the device 402 of the example of FIG. 4A) can determine if the tag has been damaged or altered.

In some embodiments, the tags are built or physically integrated directly into products (such as being hot stamped into products, or integrated in the material of products). For example, the tags can be attached to products by welding them, gluing them, melting them or sewing them into products such that attempts to remove the tag will alter the appearance of either or both the tag and the product in a manner that can be detected by the system (e.g., the host server 100 of FIG. 1 and/or the host server 300 of FIG. 3A-3B and/or the device 102A-N as shown in the example of FIG. 1 and/or the device 402 of the example of FIG. 4A) which can analyze the appearance of the tag or the product and/or the relationship between elements in the tag.

In general, each tag in a set of tags can be shipped in an inactive state and can later be activated (e.g., by the security device tracking engine 310 and/or the activation engine 344 of the host server 300) when it is attached to a product. Until tags are activated they are not associated with a particular product identifier. Once they are activated they can be authenticated. If they are later deactivated authentication will fail and display a message to the user and may also alert other parties as designated (such as the manufacturer or a regulatory authority). The system (e.g., by the authentication and verification engine 310 of the host server 300 and/or an authentication and verification engine 412 of the mobile device 402) used to authenticate tags can be trained to recognize and authenticate them, for example, using supervised or unsupervised machine learning to learn how to authenticate tags based on how the elements of the tags related and move relative to one another when the tag and/or sensor are moved relative to one another. The system (e.g., the authentication and verification engine 310 of the host server 300 and/or an authentication and verification engine 412 of the mobile device 402) can also determine whether it sees an actual tag or a reproduction of a tag, for example, by analyzing the relative movement of the sensor to the tag, and/or by detecting whether there is a flicker in the frame rate of a recording of a tag, or by altering the frequency of its own detection of the tag in order to cause interference with any potential flicker that may be present in a recording of a tag.

In some embodiment, a tag can be configured in software to authenticate a certain number of times, after which it may expire or be deactivated or may prompt a user or customer or supplier to refill it or re-allocate further budget to it. The system (e.g., the host server 100 of FIG. 1 and/or the host server 300 of FIG. 3A-3B) can enable bulk operations on sets of tags, such as activating a set of tags or deactivating a set of tags, or aggregating a set of tags, annotating a set of tags, transferring ownership to a set of tags, writing or reading data from a set of tags, generating analytics from a set of tags, searching or reporting on data in a set of tags, etc. A tag can be used to prove “proof of presence” (e.g., by the proof of presence/possession/title engine 318 of the host server 300) of a party who is proximate to a tag in order to use software to scan and authenticate that tag. A tag can also be used to prove “proof of possession” by a party of a physical object on which a tag is attached. In some instances, multiple tags can be scanned and authenticated to support an interaction or transaction. For example, a consumer may need to authenticate a tag on their ID badge, and then authenticate a tag on a product they want to purchase, while a seller may authenticate a tag on their ID badge and a tag on a product they want to sell. In general, the process of analysis uses rules-based or statistical pattern recognition techniques in computer vision, machine learning and/or image based artificial intelligence techniques (For example but not limited to convolutional neural networks) to automatically detect and track at least one non-stationary feature and/or at least one stationary feature. Additionally, geofencing can be used to prevent a tag from being authenticated and/or interacted with by sets of users within or outside of particular geographic locations or boundaries.

Some embodiments of the security device applications include augmented reality (AR) use cases, augmented reality and physical reality use-cases include using a Blocktag to generate a secure AR marker (e.g., by the AR engine 350 of the host server 300) for a physical location or object. For example, a Blocktag can be used as a secure marker at a location (on a piece of furniture, or on a piece of architecture or a tree, for example) that would be unique to that location, so the system can be certain that anyone scanning it is actually at that location. From there the system (e.g., deployed by the AR engine 350 of the host server of FIG. 3A) can then launch augmented reality, virtual reality, mixed reality, or mobile applications or transactions that are tied to that location. Examples of use-cases include using Blocktag markers on physical locations for gaming, tourism, real-estate development, building and campus management, public utilities, parking signage and parking spaces, furniture, agriculture such as attached to plants that are growing or planted in a location, physical goods such as products in a store, shelves and cabinets or other locations in a physical storefront or warehouse, tools and toolboxes, vehicles of all kinds including automobiles and aircraft and maritime, etc.

### Blockchain+Blocktag (Security Device)

References to “blockchain” generally include bitcoin- and ethereum-style blockchains as well as other distributed ledger technologies. In one embodiment, Blocktags use asymmetric cryptography in various ways, including, by way of example, not limitation:
A tag can include identity data that is associated with unique addresses (or ublic key) through a middleware layer that links a physical tag to an address.
A tag can include data to derive or retrieve the unique address (or public key)
A tag can include data to derive or retrieve public and private keys. The private key is derived from multiple optical and physical features that can be used to prove properties such as possession, and timestamp.
Or each tag references a unique address that then includes or points to data such as a public key or data records.
Resistant to replay attacks in order to provide a proof of presence, proof of possession, and proof of owners.

“Unique Addresses” can include for example, blockchain addresses, public keys, or GUIDs. The first 2 implementations allow those that possess the private keys to sign for those corresponding Blocktags (e.g., sign data onto the blockchain for these addresses). Implementation 3 allows anyone who possesses the tag at a specific time to sign for the corresponding Blocktags. All 3 implementations can be used with various backends, including but not limited to databases and blockchains. When paired with blockchain backends, this is not constrained to specific public blockchains—this is applicable on all blockchains utilizing an addressing and/or transaction system. (maybe should reword this to apply to all blockchains). For all 3 implementations, any user may submit data. However, with implementation 3, there is proof of possession. In a consumer implementation that involves product reviews, those that can prove possession have a more legitimate review.

Bloektag with Respect to other Blocktags

Blocktags can also have 1 to 1, 1 to many, and many to many relationships with other Blocktags. For example, many individual items may be packaged in a parcel, and many parcels may be packaged in a shipping container. For instance, to verify the contents of the shipping container without opening it, them could be a Blocktag that seals the container and stores the Blocktag data of all the contents.

### Blocktags+Reputation Systems

There are a few ways a user can submit data related to an item that a Blocktag is associated with or attached to.

1. implementation 3 allows users to sign data to the Blocktag's address directly. This data can be cosigned with a user's personal private key, proving the user's identity+product's identity.

2. All implementations let users sign data associated with a product with their own private key, optionally onto a blockchain. Since the signed data is associated with an identity, there can be an on or off-chain system for storing a reputation metric.

Reputation metrics can be calculated from various inputs including but not limited to public key age, activity, and off chain sources (DNB, BBB, brand recognition, market cap). For example, when a user has reviewed a lot of products over a long period of time, they have more reputation capital for future reviews. A user who has reviewed only few products do not have much weight, given the simplicity of creating a new account. In the supply chain use case, a well known manufacturer with a published public key would have immediate credibility due to off chain sources (e.g., brand recognition). A well used shipping port would build up transactions quickly and maintain a high number of transactions, also giving them credibility relatively quickly.

Reputation systems depend on use-case and available data sources for each use case.

Proof of Presence: the system (e.g., the host server 100 of FIG. 1 and/or the host server 300 of FIG. 3A-3B and/or the device 102A-N as shown in the example of FIG. 1 and/or the device 402 of the example of FIG. 4A) can prove to a local or remote 3rd party, that a particular user/identity, or someone in possession of the private keys for a private/public keypair, is in a line of sight presence of an authenticated Blocktag at a particular moment in time. For example: a Blocktag tagged item that can be seen through a store window can be scanned to prove the user's relative physical proximity with the tag.

Proof of Possession; the system (e.g., the host server 100 of FIG. 1 and/or the host server 300 of FIG. 3A-3B and/or the device 102A-N as shown in the example of FIG. 1 and/or the device 402 of the example of FIG. 4A) can prove to a local or remote 3rd party, that a particular user/identity, or someone in possession of the private keys for a private/public keypair, is in a line of sight presence of an authenticated Blocktag and has physical control of the aforementioned tag, at a moment time. Proof of Possession can imply Proof of Presence. For example, a Blocktag tagged item that is held in in one's hand can be scanned to prove the user's physical control over the tag.

Proof of Title: the system (e.g., the host server 100 of FIG. 1 and/or the host server 300 of FIG. 3A-3B and/or the device 102A-N as shown in the example of FIG. 1 and/or the device 402 of the example of FIG. 4A) can prove to a local or remote 3rd party, that particular user/identity, or someone in possession of the private keys for a private/public keypair, has title/ownership of a tag and/or the item attached to the tag. This includes being able to do something with the tag that proves you have title to it, or by doing something on the blockchain entry for the tag that proves you control that corresponding blockchain address.

### AR (Augmented Reality) to Assist in Scan

In some embodiment, the system (e.g., the host server 100 of FIG. 1 and/or the host server 300 of FIG. 3A-3B and/or the device 102A-N as shown in the example of FIG. 1 and/or the device 402 of the example of FIG. 4A) can deploy or utilize an augmented reality (AR) environment to guide user scanning in the right directions. It may not correspond entirely with user movement. There can be virtual objects in 3D or other visual targeting queues to help guide the user to move their device (e.g. the device 102A-N as shown in the example of FIG. 1 and/or the device 402 of the example of FIG. 4A) into the right orientation in 3 dimensions, and then to follow a specific path and set of changes in orientation over time and space to move their device in a specific way, relative to a Blocktag that is being tested. This provides visual feedback (and optionally also haptic and audio feedback) to help the user perform a specific motion or sequence of motions with their camera and/or by moving the Blocktag (or the carder of the Blocktag) to generate a series of still images or video frames or other sensor data measurements, in a particular path through space and time.

Linking to or from a Blocktag

The system (e.g., the host server 100 of FIG. 1 and/or the host server 300 of FIG. 3A-3B and/or the device 102A-N as shown in the example of FIG. 1 and/or the device 402 of the example of FIG. 4A) can launch any addressable piece of content of functionality on a network or device—such as a URI, or deep link (or URI or any addressable piece of data or software anywhere) from a Blocktag. The address to be launched can be derived from the Blocktag in a number of ways: It can be stored in the QR code for the Blocktag, or another associated 2D bar code or other type of coded image or symbols; it can also be stored in a database location, such as in the blockchain entry for the particular serialized tag, or in another location that is pointed to from the blockchain entry or database location, for that particular tag.

For example from a Blocktag, the system can launch a Web URL or a deep link on the user's local mobile device. Here is an example showing how the system launches an augmented reality experience from a physical product, using the Blocktag app, a physical product with a Blocktag label on it, and any AR mobile app (it could be any app). This enables launching of permission-based digital experiences (text or files, AR, VR, music, video, software, special offers, NFTs and crypto wallets, online shopping locations, or any data record or location in any application, etc.) from authenticated Blocktags. Only if the Blocktag is authenticated will the Blocktag app then launch the associated addressed data or application or address.

The disclosed technology is an improvement over using QR codes as markers for AR because using a Blocktag enables access to something else, only if the Blocktag is authenticated first. Before or after the authentication of the Blocktag we can also require or request authentication of the user and/or even other Blocktags or other apps and services (for example using external authorization or two-factor authentication). This enables the system components or software, or any 3rd party component using the Blocktag API or SDK, to allow access to content and other functionality, conditionally on authentication of a Blocktag and optionally also other things such as the user of the Blocktag app, etc.

The disclosed technology also enables the target that is launched to be dynamic depending on who the user is, their geolocation, the time, the user context and intent, what product the tag is on, the history or state of the tag, or other data in a database or application that corresponds to the tag. Note also that an application or content can link to a Blocktag address, as well as being linked from a Blocktag. For example, on a Web page there could be a link to a Blocktag. That link would resolve to the a Web page about that Blocktag that is derived from the latest information about that tag from the blockchain and/or databases and/or other applications.

Associating Blocktags with other Entities

Entities can interact with Blocktags in a variety of ways. Entities that hold a private key can associate data with each Blocktag by signing data with their own private key, with each Blocktag's private key, or both in combination. For example, a manufacturer, a testing lab, and a distributor can each certify that they've interacted with a specific Blocktag before using this scheme. The last entity to interact with a Blocktag can also gain special privileges, such as being the only one to receive messages.

### Blocktag Wallet/Interface

Any entity that has interacted with a Blocktag may also be able to include a virtual version of the physical item attached to the Blocktag in a virtual wallet, such as a wallet app. This interface may or may not be attached to a blockchain, but can be an interface between an entity, a broader network of Blocktags, and other entities participating in the Blocktag ecosystem. This interface allows entities to interact with the Blocktag (e.g., activation/deactivation, scanning, reading, verification, proof of possession/presence/ownership), access messaging/notifications, social features (e.g., social network between Blocktag network participants), and redeem other offers included with each Blocktag (e.g., non-fungible tokens, digital collectibles, raffle tickets, access passes, coupons).

### Messaging to Blocktag Addresses

A message could be sent to that Blocktag by addressing it to the serial number of the Blocktag. The message would be cached until the owner of the Blocktag scans the Blocktag, at which point it would be delivered to the owner of the Blocktag in the Blocktag app. A message could be delivered to a Blocktag synchronously or asynchronously (e.g., by the social connection engine 360 and/or the messaging engine 362 of the host server 300). if a device having a particular Blocktag address has a network connection, information could be addressed to the Blocktag (e.g., by the social connection engine 360 and/or the messaging engine 362 of the host server 300) and could then be referred to the device (e.g., the device 102A-N as shown in the example of FIG. 1 and/or the device 402 of the example of FIG. 4A) that carries the Blocktag.

The database (e.g., the ledger address repository of FIG. 3A and/or the ledger address repository 126 of FIG. 1) such as a blockchairt could hold a pointer to the network address of the device that carries the Blocktag. if there is one. If a Blocktag is on something that does not have another network address or device to deliver messages to, then the database or blockchain for Blocktags acts as a stare-and-forward cache (for example a mailbox) for each tag. Messages can be addressed to particular users/tags, classes of users/tags, and targeted to specific actions or contexts (geography, time, date, type of location, user profile, user intent or query context, etc.). This process can enable targeted messages to be sent and delivered to various different user populations (guests, customers. owners, employees, etc.) of a Blocktag or set of Blocktags according to rules and dynamically changing criteria and situations. There may also be permissions or rules set so that only certain entities can send messages to certain Blocktag addresses. For example. the system (e.g., the host server 100 of FIG. 1 and/or the host server 300 of FIG. 3A-3B and/or the device 102A-N as shown in the example of FIG. 1 and/or the device 402 of the example of FIG. 4A) can be implemented such that only companies in the supply chain of product A may send messages to those who hold product A. Messages are not limited to text, and may also include any binary data. Sample use cases include text messages, images, coupons that require additional proof to fulfil (such as require proof of presence, possession, and/or ownership).

### Tamper Resistance of Tag Portions of Tag

Some Blocktags can include simple printed patterns such as 1d/2/3d barcodes. QR codes, and datamatrix codes. Someone may try to overlay another pattern over these printed patterns in an attempt to authenticate the tag. To prevent such vulnerabilities, each printable pattern (and contained data) is hashed along with the non-printable microlens) area in the derivation of the identity. If either the printable pattern or the non-printable area is compromised, the whole tag is deauthenticated.

### Calculating Viewing Angle

The perspective at which a camera views a tag can be calculated using a reference shape of known size, for example, a 2d barcode on the tag. When viewing the tag from a non-normal angle, the 2d barcode will look skewed. The plane on which the tag is can be found from the skew, and the normal vector can represent the viewing angle. Size of the reference shape can be used to determine distance. Using this vector, the expected image shift from the microlens can be calculated as a translation from what is visible from the perspective of any other vector that was recorded in the past (e.g., during activation of the tag, during other authentication actions taken by users).

A tag says that QR q that points to URL k is on the tag with identity x and authenticity y. When launched in our app we can show content for (q, k, x, y) but if not launched in our app then at least we can show the content for k. In one embodiment, all QRs go to our domain with our certificate. To prevent spoofing we need to print the QRs with special ink—to verify they have not been tampered with. We can also look for signs of tampering but how do we defend against someone doing a very clean cut and paste of a different QR onto one of our tags? There has to be something visible that makes our QRs distinct and impossible to spoof. One way to do it would be to have them appear on a diffractive material, or to have them on the microlens. One further embodiment of the present disclosure includes a QR in the middle and then around it is proprietary encoding. We only use the QR part for the “Get Blocktag” page. Something else that only our app can see and open. We would give up backwards compatibility but would gain elimination of malicious QRs. We would encrypt a target into our code in an irreversible way. Our app sees our code and does something. Our code looks different from a QR but could contain a QR to get our app.

### Additional Process for Serialization

Suppose that the serialization on a tag is a 1 time pad, having m different keys each of length n, in it. The m different keys are arranged in a sequence of m*n bits. Suppose we therefore want 1000 keys of 128 bits, so we have a 1.2 kilobit string. The system can then run that string through an irreversible hash function to generate a new string into which the digits of this string are scrambled. Each tag has this 1.2 k number encoded onto it. The number could even be in the QR code. Every time a tag is scanned, the system can permanently use up 1 of the keys (pages of the one-time pad). Only the system knows how to look for the keys on the tag. And whenever a valid key is first read, we note that the key has been “used,” at the blockchain address of that key. When a tag is scanned, the system gets all its keys, the scrambled 1.2 k number. Then we check if that set of m keys is a valid set of keys. Then we check if there are any scans left in that set of keys (are there any pages of the one-time pad remaining) (edited) No matter who scans the tag—we burn a key each time. After the tag has been scanned m times, all the keys have been used up for that tag.

Now let's say someone counterfeited your tag by copying it. Either the counterfeit tag will contain a key that is valid or invalid. If it is valid it will either have scans left on it or not. So in this scheme, the system could print this number on each tag. As the population of users of that tag scan, the key gets used up for that tag. If someone counterfeits it, and the counterfeits generate scans, those scans will use up the keys faster. However since this is simply a printed serial number essentially, you can limit the potential risk of counterfeiting simply by printing a different key on every single item. So every tag has a random number on it. We can either hide that number or put it in the clear. That number contains m keys, which allows for m scans, because every scan is memorialized on the ledger, and/or burns the token for that scan. Assume that a manufacturer has a budget to spend on scans of a tag—A scan costs 1 token. They release 1 million tags on 1 million units of their product, and for that set of tags they buy 5 million scans. This allows for customers of those tags to each scan 5 times on average, or for some amount of customer scans and/or counterfeit scans. But now the manufacturer controls the amount of loss from counterfeiting. They make it easy to counterfeit, but only 5 times, for example. However, the odds will be that those scans are all used up by authorized customers before anyone has time to make and distribute counterfeits.

The pad is different on each tag, visible on each tag, but scrambled. Once all the keys are used for each tag, if anyone tries to scan it they are notified that all the keys are used. If someone scans, how do they know that they are scanning an authentic or fake tag? Is this tag an original or a copy of an original or of a copy? They know through a statistical argument. When someone scans a tag, we can show them the probability that the thing they are scanning is authentic or fake, based on the usage of the one-time pad for that key across other scans. The system can create a set of mathematically related pads, so that any key that is used from any pad in the set can be associated with the other pads. The system can then see when any tag is used, and what set of tags it is from. The system can detect suspicious scan activity and raise the “warning level” for various tags or sets of tags. For example each factory could generate distinct mathematically signed one-time pads. If there is a lot of counterfeiting we know where those tags originated. Similarly each scan happens at a time and place, and the system can look at those patterns too. The trade off is that no tag can be scanned an infinite number of times. To limit potential counterfeits, you have to limit the number of scans allowed per serial number. This can be acceptable in cases where consumers are not expected to scan once per person on average, or where the number of scans per person on average can be at least predicted. Simply cut off the allowable scans at some threshold and at least counterfeits won't work after a certain amount of scans. Also counterfeiters have risk—because every scan will show the person scanning how many scans remain If counterfeiters make lots of copies of the same tag, their customers will all likely scan the same tag and use up the available scans very fast. So counterfeiters would need to counterfeit more tags and put them on their products in series. This would further limit the potential profit of counterfeiters. A given tag has a probability of being an original or a copy, which changes over time. It might change unpredictably or predictably, depending on what the tag is on. The system can show that score on each scan.

The first scan has a 100% probability of being the original scan. If the same tag is scanned a second time, then depending on how many scans have already happened, how fast they happened, where they took place, there is a varying probability that the second scan is on the original, or a copy. In the worst case, there is a built-in limit on the number of scans allowed, so the damage a counterfeiter can do is limited. Therefore, the security device can have authenticity from the micro-lens and serialized with a printed pattern. The serial number can be in the clear, or in the barcode. Every time anyone scans that barcode in our app, with an authenticity seal next to it, it burns 1 token for that tag. If they scan that barcode without the authenticity seal with the scan, the system can see that. Every tag is essentially a pile of free tokens. Every time someone scans it, they spend one of those tokens. Let's say manufacturers (e.g., third party tag generator entity 112 of the example of FIG. 1) pay the host (e.g., Blocktag Manufacturer, the host entity which hosts or administers the host server 100 of FIG. 1 and/or the host server 300 of FIG. 3A-3B) 3×the number of tokens for the number of tags they issue. We keep 2 of those, The system pays 1 to the consumer who scans. So for 1000 tags, a manufacturer (e.g., third party tag generator entity 112 of the example of FIG. 1) wants to buy 10 scans per tag, so the price is 3*10*1000=30,000 tokens. We as host (e.g., Blocktag Manufacturer, the host entity which hosts or administers the host server 100 of FIG. 1 and/or the host server 300 of FIG. 3A-3B) get 20,000 tokens, and we pay out 10,000 tokens to scanners. If there is counterfeiting scans will simply not work anymore. That means they will alert scanners that the tokens are used up, and they also won't pay out. Let's say that the token also has a scratch off cover. People cannot scan the token until they scratch that off, which isn't going to happen if it is sitting on a shelf in a retail store. So the system always can tell the difference between the first scan, and a non-first-scan. The first scan has 100% probability of being from an original product. Subsequent scans have a probability of being authentic. The system (e.g., the host server 100 of FIG. 1 and/or the host server 300 of FIG. 3A-3B) can drastically improve this probability score simply by virtue of our app looking for the authenticity part of the tag (the microlens). However, in the worst case if someone were to copy a tag, or scan it without the microlens there, the system will only allow that to happen a finite number of times. Consumers would have to then trust our app and our authenticity score, and we would have to educate them to use our app and look for the special authenticity microlens etc.

The chances of anything being counterfeit are very low because of the special microlens design etc. The counterfeiters would have to make or get micro-lenses that fool our app. We also show consumers the probability that any scan of the QR is authentic. If the microlens is present, the probability is very high. If it is not, the probability is lower. The points get used up either way, and the brand gets the data. Consumers get paid, until supplies run out. The built in scarcity is a forcing function that gets consumers to race to get the points. At the same time it limits the potential damage of anyone simply stealing the QR. What if someone just scans the same QR over and over? Does that use up all the keys on the pad, and thus the entire points budget? It could. To prevent that the system could pay out only when it is a QR can that has an associated micro-lens. That limits some of that activity. However, someone who has a valid tag with a microlens could still scan repeatedly. That would use up all the points for the tag. The system could limit that by not allowing the same QR to pay out more than n times an hour per geographic location. The QR code can include a serial number that works forever or stops working after n scans. Blocktag software app can detect if the QR code is paired with a microlens. The first scan is different because it is the first time the QR code is uncovered (via the scratch-off surface covering it). The system can detect subsequent scans, as well as subsequent scans by the same user. The system can either reward subsequent scans by the same user or penalize them. It is fine-grain adjustable. A brand could also make their reward budget only reward subsequent scans by the same user. The first scan is always authentic because the scratch-off covering above the QR can only be removed once. Subsequent scans are now differentiable from the first scan.

### Data Capture

Each tag has many unique features, which can be categorized into the following categories:

1. Chaotic: unique features that stem from entropy during manufacture and application. Small changes in initial manufacturing conditions cause changes large enough to be detectable, and therefore make these features much more difficult, or impossible, to reproduce.

2. Controlled: unique features that are designed and do not stem from entropy, for example, 1d/2d/3d barcodes, printing patterns, printing substrate features, ink splatter.

While the controlled features can be recorded prior to manufacture, the chaotic features can be integrated during manufacture and therefore must be recorded after each or all features are manufactured. Chaotic features can be split into additional categories: changing relative to viewing angle and distance, nonmoving, colors, shapes, etc. To capture all optical features and how they react to different conditions, an array of cameras is placed on a semicircle around a conveyor belt with tags moving through it, taking multiple images/video as the tags move through it. The tags can then be rotated to other angles and passed through the camera semicircle in order to have a spherical scan of every tag. Alternatively, cameras can be arranged in a hemisphere or a subset of a hemisphere pointing towards a conveyor belt. This also provides a spherical scan of every tag. Camera assemblies can be scaled up and down with multiple on the same manufacturing line to retrieve uniqueness data on each tag based on a wide gamut of inputs such as viewing angle, distance, and lighting. A variation is having two cameras at different locations above a conveyor belt such that a tag passing through the conveyor belt is visible by both cameras at the same time. In addition, cameras may be outfitted with wide angle lenses to capture more angles as the tags move past. For authentication and identification, instead of variable viewing angles from a hand controlled camera (e.g., an optical sensor/optical device of a scan device, optical sensor/optical device of a user device or device 102A-N as shown in the example of FIG. 1 and/or a device 402 of the example of FIG. 4A), there can also be two or more cameras at unique fixed viewing angles for stationary and moving tags, and one or more cameras at fixed viewing angles for moving tags.

FIG. 3A depicts an example functional block diagram of a host server 300 to administer, generate. track, authenticate security devices in a network, in accordance with embodiments of the present disclosure.

The host server 300 includes a network interface 302, an authentication and verification engine 310, a security device (Blocktag/tag) tracking engine 340, an augmented reality (AR) engine 350 and/or a social connection engine 360. The host server 300 is also coupled to a security device (Blocktag/tag) repository 322, a tag identity/property repository 324 and/or a ledger address repository 326. Each of the authentication and verification engine 310, the security device tracking engine 340, the AR engine 350 and/or the social connection engine 360 can be coupled to each other. One embodiment of the authentication and verification engine 310 includes, an optical characteristics and position analyzer 312, an image analysis engine 314 having a feature extractor and detector 315 and/or a proof of presence/possession/title engine 318. One embodiment of the security device tracking engine 340 includes, a serial ID generator 342 and/or an activation engine 344.

Additional or less modules can be included without deviating from the techniques discussed in this disclosure. In addition, each module in the example of FIG. 3A can include any number and combination of sub-modules, and systems, implemented with any combination of hardware and/or software modules. The host server 300, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

One embodiment of the host server 300 includes the authentication and verification engine 310 having, the optical characteristics and position analyzer 312, the image analysis engine 314 having the feature extractor and detector 315 and/or the proof of presence/possession/title engine 318. The authentication and verification engine 310 can be any combination of software agents and/or hardware modules (e.g., including processors and/or memory units). One embodiment of the host server 300 further includes the security device tracking engine 340 having the serial 1D generator 342 and/or the activation engine 344. The security device tracking engine 340 can be any combination of software agents and/or hardware modules (e.g., including processors and/or memory units). One embodiment of the host server 300 further includes the AR engine 350. The AR engine 350 can be any combination of software agents and/or hardware modules (e.g., including processors and/or memory units). One embodiment of the host server 300 further includes the social connection engine 360 having the messaging engine 363. The social connection engine 360 can be any combination of software agents and/or hardware modules (e.g., including processors and/or memory units).

FIG. 3B depicts an example block diagram illustrating the components of the host server 300 to administer, generate, track, authenticate security devices in a network, in accordance with embodiments of the present disclosure.

In one embodiment, host server 300 includes a network interface 302, a processing unit 334, a memory unit 336, a storage unit 338, a location sensor 340, and/or a timing module 342. Additional or less units or modules may be included. The host server 300 can be any combination of hardware components and/or software agents to administer, generate, track, authenticate security devices in a network. The network interface 302 has been described in the example of FIG. 3A. One embodiment of the host server 300 includes a processing unit 334. The data received from the network interface 302, location sensor 340, and/or the timing module 342 can be input to a processing unit 334. The location sensor 340 can include GPS receivers, RF transceiver, an optical rangefinder, etc. The timing module 342 can include an internal clock, a connection to a time server (via NTP), an atomic clock, a GPS master clock, etc. The processing unit 334 can include one or more processors, CPUs, microcontrollers, FPGAs, ASICs, DSPs, or any combination of the above. Data that is input to the host server 300 can be processed by the processing unit 334 and output to a display and/or output via a wired or wireless connection to an external device, such as a mobile phone, a portable device, a host or server computer by way of a communications component. One embodiment of the host server 300 includes a memory unit 336 and a storage unit 338. The memory unit 335 and a storage unit 338 are, in some embodiments, coupled to the processing unit 334. The memory unit can include volatile and/or non-volatile memory. The processing unit 334 may perform one or more processes related to administering, generating, tracking, and/or authenticating security devices. In some embodiments, any portion of or all of the functions described of the various example modules in the host server 300 of the example of FIG. 3A can be performed by the processing unit 334.

FIG. 4A depicts an example functional block diagram of a client device 402 such as a mobile device that can obtain data from security devices, in accordance with embodiments of the present disclosure.

The client device 402 includes a network interface 404, a timing module 406, an RF sensor 407, a location sensor 408, an image sensor 409, an authentication and verification engine 412 having an optical characteristics and position analyzer 413, an image analysis engine 414 having a feature extractor and detector 415, a user stimulus sensor 416, a motion/gesture sensor 418, a capture engine/scanner 420, an audio/video output module 422, and/or other sensors 410. The client device 402 may be any electronic device such as the devices described in conjunction with the client devices 102A-N in the example of FIG. 1 including but not limited to portable devices, a computer, a server, location-aware devices, mobile phones, PDAs, laptops, palmtops, iPhones, cover headsets, heads-up displays, helmet mounted display, head-mounted display, scanned-beam display, smart lens, monocles, smart glasses/goggles, wearable computer such as mobile enabled watches or eyewear, and/or any other mobile interfaces and viewing devices, etc. In one embodiment, the client device 402 is coupled to a scan log and authentication challenge repository 428. The scan log and authentication challenge repository 428 may be internal to or coupled to the mobile device 402 but the contents stored therein can be further described with reference to the example of the scan log and authentication challenge repository 128 shown in the example of FIG. 1.

Additional or less modules can be included without deviating from the novel art of this disclosure. In addition, each module in the example of FIG. 4A can include any number and combination of sub-modules, and systems, implemented with any combination of hardware and/or software modules. The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software. In the example of FIG. 4A, the network interface 404 can be a networking device that enables the client device 402 to mediate data in a network with an entity that is external to the host server, through any known and/or convenient communications protocol supported by the host and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater. The client device 402 can provide functionalities described herein via a consumer client application (app) (e.g., consumer app, client app, etc.).The consumer application includes a user interface that enables access to the chat, opening or otherwise interacting with a chat message through virtual items or virtual objects.

FIG. 4B depicts an example block diagram of the client device 402, which can be a mobile device that an obtain data from security devices, in accordance with embodiments of the present disclosure.

In one embodiment, client device 402 (e.g., a user device) includes a network interface 432, a processing unit 434, a memory unit 436, a storage unit 438, a location sensor 440, an accelerometer/motion sensor 442, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for reading, provisioning, scanning, detecting, decoding, identifying security devices and/or retrieving relevant data from security devices. The network interface 432 has been described in the example of FIG. 4A.

One embodiment of the client device 402 further includes a processing unit 434. The location sensor 440, accelerometer/motion sensor 442, and timer 444 have been described with reference to the example of FIG. 4A. The processing unit 434 can include one or more processors, CPUs, microcontrollers, FPGAs, ASICs, DSPs, or any combination of the above. Data that is input to the client device 402 for example, via the image capture unit 452, pointing device/sensor 454, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer that generates and controls access to simulated objects by way of a communications component. One embodiment of the client device 402 further includes a memory unit 436 and a storage unit 438. The memory unit 436 and a storage unit 438 are, in some embodiments, coupled to the processing unit 434. The memory unit can include volatile and/or non-volatile memory. The processing unit 434 can perform one or more processes related to reading, provisioning, scanning, detecting, decoding, identifying security devices and/or retrieving relevant data from security devices. In some embodiments, any portion of or all of the functions described of the various example modules in the client device 402 of the example of FIG. 4A can be performed by the processing unit 434. In particular, with reference to the mobile device illustrated in FIG. 4A, various sensors and/or modules can be performed via any of the combinations of modules in the control subsystem that are not illustrated, including, but not limited to, the processing unit 434 and/or the memory unit 436.

FIG. 5A-FIG. 5B depict flow charts illustrating example processes for authentication of a security device, in accordance with embodiments of the present disclosure.

The system can determine or provide the authenticity of Blocktag, for example, using a software application on a smartphone, optical sensor, electronic sensor, or computer hardware device. In one embodiment, the authenticity of a Blocktag can determined by acquiring a series of at least two sequential images of a Blocktag in process 502 and comparing at least two sequential images of the Blocktag, in process 504 to detect changes in optical characteristics between one image and another image of the Blocktag, as in process 506. It can then be determined whether the images of the Blocktag include at least one recognized stationary feature and one recognized non-stationary feature as in process 508. If no recognized feature is detected in at least two sequential images, the system can acquire more sequential images of the Blocktag until a specified number of images are found in sequence where each image includes the recognized features. If no feature is detected go the process is repeated starting from process 502 until it is detected. The serialization and authentication process can include the following state transition steps, which can be in any order. In process 512, the camera lens focus on a tag is adjusted. In process 514, a QR/barcode is detect and decoded. In process 516, the serial ID is read from a colormap. In process 518, an area in software is defined to find microlens symbol (e.g. OK symbol). In process 520 a microlens symbol is detected in software defined area. In process 522, the detected microlens symbol is tracked across multiple video frames.

For example, the user can tap on the sensor's screen to manually adjust camera lens focus on the tag's elements (QR, Barcode etc.) in one of the steps towards successful overt authentication. Covert authentication uses camera to take snapshots of not only the tag but also neighboring product surface elements around the tag. The relative positions between the tag and the product's surface elements can be used to check if the tag has been tampered, displaced or modified in anyway by bad actors from the original intended location on the product's surface. Software analysis uses computer vision, machine learning and/or image based artificial intelligence techniques (For example but not limited to convolutional neural networks) to automatically detect and track at least one non-stationary feature and/or at least one stationary feature of a Blocktag. In addition to visual feedback from sensor's display, vibrations produced by sensor can be used to guide end users towards successful authentication. One example is tag can be authenticated directly when sensor takes snapshots of the tag while producing short vibrations. Another example is sensor's vibration intensity increases as a way to engage and guide user in holding a microlens symbol in box towards successful authentication. In addition to visual and vibrational feedback from sensor's display, sounds produced by sensor can be used to guide end users towards successful authentication. One example is sensor's sound output volume increases as a way to engage and guide user in holding a microlens symbol in box towards successful authentication.

In one embodiment, augmented reality (AR) capabilities are integrated into the interactive authentication process to improve security. For example, virtual design elements and text (e.g. “Move OK into box”) can be displayed over the physical tag on the mobile phone's screen to guide users in authenticating tag across multiple video frames. In addition to overt symbol authentication, another layer of security involves detecting and representing the Red Blue Green (RGB) or Hue Saturation Value (HSV) colorspace spectrums associated with a security device as a covert security feature. The RGB and HSV spectrums can be represented as a histogram of pixel value bins as shown in the example of FIG. 7B.

FIG. 6A depicts images showing examples of unique cuts of a microlens array, viewed from the normal vector, in accordance with embodiments of the present disclosure.

When a sheet of microlens array is cut to make tags, there is a difference in the symbol's position at a constant viewing angle per tag, due to the cut along a plane of the microlens sheet. Viewing each tag from a constant vector of the microlens plane yields a different patterns. This contributes to the irreproducibility of the authenticity and identity components of a security device. Since this random parameter is known only after the identity component (e.g., The color barcode) of a security device is printed and the microlens array cut and pasted on the color barcode, this parameter can be stored on a host server (e.g., the host server 100 in the example of FIG. 1 and/or host server 300 as shown in the example of FIG. 3A-3B). The parameter can also be stored in a blockchain and appended to the identity component's encoded serial ID. In this way, no one, not even the Blocktag's original manufacturer (e.g., the third party tag generator entity 112 shown in the example of FIG. 1), can reproduce the unique combination of the cut microlens array component (authenticity component of the security device) and halftoned color barcode component (identity component). In one illustrative example, image (a) 602 can be arbitrarily set as the base pattern, then the others have unique features:

image (b) 604: translation: (−5px, −5px), rotation: 0°, symbol: star

image (c) 606: translation: (0px, 0px), rotation: 30°, symbol: star

image (d) 608: translation: (−5px, −5px), rotation: 30°, symbol: star

image (e) 610: translation: (6px, −7px), rotation: 35°, symbol: club

image (f) 612: translation: (0px, −5px), rotation: 35°, symbol: club, distortion: true

image (g) 614: translation: (0px, −5px), rotation: 35°, symbol: club, distortion: true, dot: (15px, −13px)

Note that recording does not need to take place from the normal vector, as long as it is recorded.

FIG. 6B depicts examples of a serial identifier of an identity component of a security device, in accordance with embodiments of the present disclosure.

### Serialization

Each security device or tag is uniquely identified with a serial ID (identifier component of the tag). In one embodiment, the serial ID used in the security device (or tag, Blocktag) is implemented a colored barcode (e.g., Just Another Barcode (JAB). A JAB solid colored barcode example is shown in 620. In some instances, Blocktag's serial ID can be encoded as a colored barcode such as as a JAB 2D barcode. The serial ID can also be encoded or more generally, as variations of this 2d color barcode template. For example, a height dimension can be printed or fabricated on top of a 2d barcode template to produce a 3d colored barcode. The serial ID can also be encoded by modifying various properties (such as color, patterns, texture etc.) of each small square in the colored barcode (e.g. referred to as ‘Modules’ in JAB terminology). For example, instead of solid colored small squares, print halftone colored small squares. A variation of the JAB solid colored barcode example is shown in 630. To decode the serial ID string from a colored barcode (e.g., JAB), it's position can be detected first using colored markers designed in the barcode. Note that in the example, of JAB, JAB was originally designed as a high capacity storage alternative to QR by using colors but the tradeoff is colors negatively impact JAB detection compared to black-white QR detection. Any stray pixel whose color is different from neighboring pixels will compromise detection consistency, hence the system's ease of use.

Therefore, new pre-processing steps are applied to the colored barcode (e.g., JAB) to perform Blocktag serialization to generate the serial ID. In these pre-processing steps the colored barcode is not viewed as an alternative to QR, but is complementary to QR. The security device combines large address space of the colored barcode's high capacity storage with QR's robust detection consistency/ease of use. Note that once these pre-processing steps are integrated, only the disclosed system can read these colored bar codes. The default or standard JAB reader is unable to read these pre-processed colored bar codes. These pre-processing steps can include for example:

1. Use markers with higher detection consistency (e.g. QR) outside JAB's colored barcode to infer JAB's position. Specifically, JAB's position is preset on the tag relative to the QR position during the manufacturing stage. When QR is detected using the Blocktag app, QR's marker positions are known and JAB's position can be inferred subsequently using vector math.

2. Deploying or utilizing an Augmented Reality (AR) user interface to assist users in reading the tag's serial ID robustly under different lighting conditions. The system components or software can detect a physical tag's Code Area and overlays it with pixels on the phone display. The pixel overlay is used as feedback for users to orientate the phone correctly. For example, in order for serial ID to be read, all red/green/blue printed areas must be overlayed with magenta/yellow/cyan pixels.

3. The color barcode (Or any physical design having a tiled pattern like QR) can also be used as a reference pattern for OpenCV to quantify the phone camera's characteristics (e.g., radial/tangential distortion) and 3D orientation of the tag (e.g. Pitch, roll, yaw) and/or any physical goods the tag is attached to.

4. The color barcode can also be paired with microlens (e.g. Place the color barcode behind microlens) to ensure uniqueness of the microlens used for authentication. Although the microlens symbol obscures the underlying JAB, it's serial ID can still be decoded as pixels are virtualized.

FIG. 7A depicts user interfaces 710 and 720 showing using external the top left, top right and bottom right markers of a QR code to infer the position a color barcode, in accordance with embodiments of the present disclosure. User interface 710 depicts an example of a color barcode which has been virtualized. FIG. 7B depicts a graph showing how spectrum can be represented as a histogram of pixel value bins, in accordance with embodiments of the present disclosure. Specifically, the RGB and HSV spectrums can be represented as a histogram of pixel value bins are shown. The spectrum can be derived directly from the microlens layer of the security device. The spectrum can also be embedded in another transparent layer and placed on top of the microlens layer. In yet a further approach, a surface or ink that has different spectrums when viewed from different angles can be printed beneath the lens or spray coated on the security devices. Successful spectrum based authentication of a security device (tag) can include, for example, determining whether: the correlation coefficient of the security device's spectrum captured by a video frame is above a certain threshold when compared with a known baseline and/or whether the spectrum shift of the security device captured from one video frame to another is within an expected threshold.

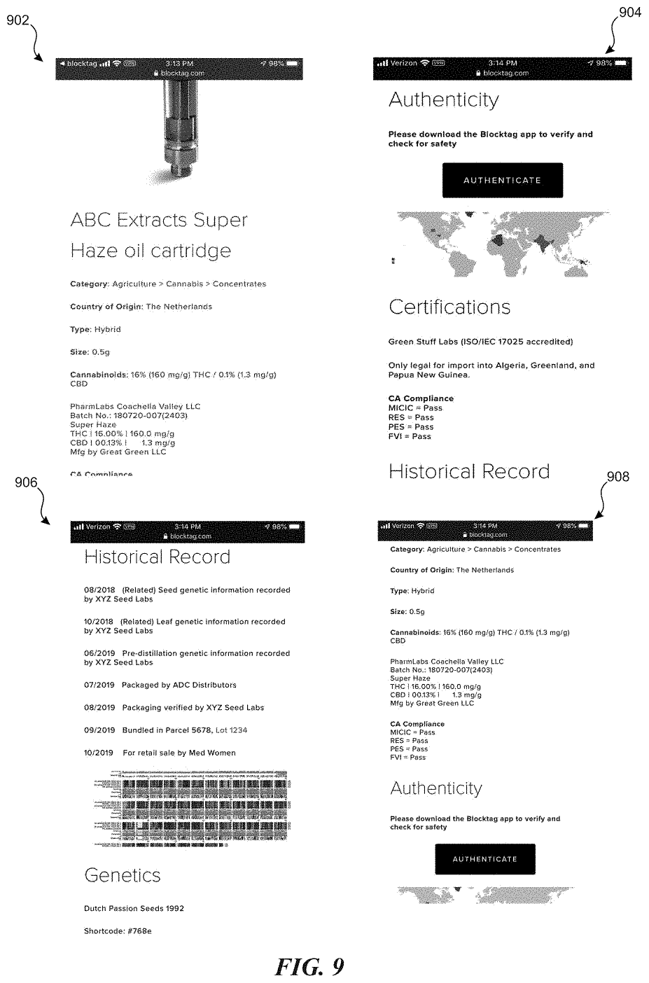

FIG. 8 depicts example user interfaces for reading, decoding or authenticating a security device, in accordance with embodiments of the present disclosure. User interface 810 depicts an example user interface showing an example of successful decoding of URL link from QR and serial ID from a color bar code, in accordance with embodiments of the present disclosure. User interface 820 depicts an example user interface showing an example of successful serial ID reading of a color bar code with microlens layer placed in front, in accordance with embodiments of the present disclosure. User interface 830 depicts an example user interface showing an example of successful authentication without an underlying color bar code and an option to launch link showing more information on product associated with this security device, in accordance with embodiments of the present disclosure. Note that the QR could be in the middle of a tag, with symbols on more than one side of it, and even with symbols right above the QR. User interface 840 depicts an example user interface showing an example of successful authentication of OK microlens symbol with an underlying color bar code, in accordance with embodiments of the present disclosure. User interface 850 depicts an example user interface showing using augmented reality treatment of user interface in OK symbol to guide users towards successful authentication, in accordance with embodiments of the present disclosure. FIG. 9 depicts user interfaces 902, 904, 906 and 908 showing product information retrieved from a security device, in accordance with embodiments of the present disclosure.

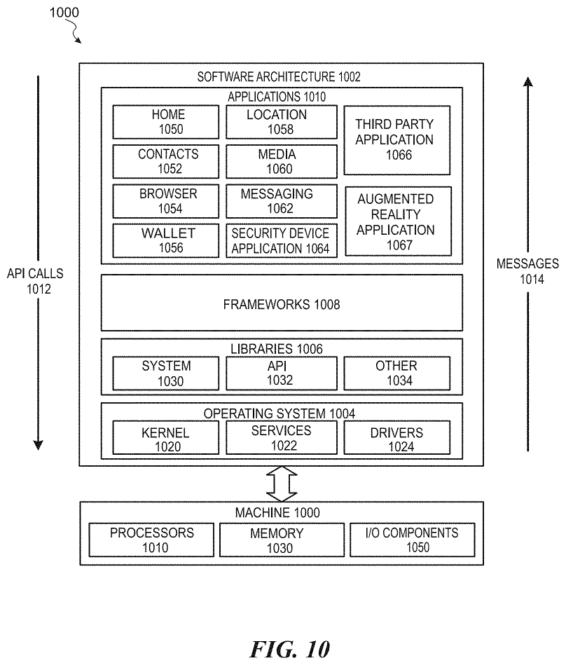

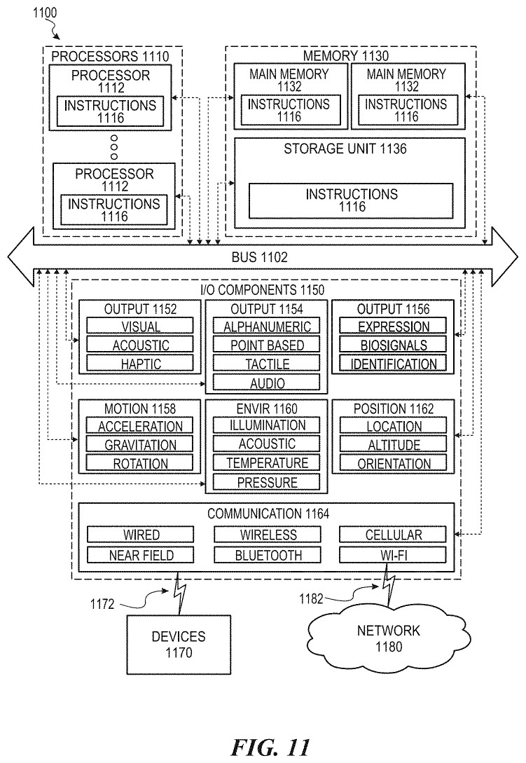

FIG. 10 is a block diagram 1000 illustrating an architecture of software 1002, which can be installed on any one or more of the devices described above. FIG. 10 is a non-limiting example of a software architecture, and it will be appreciated that many other architectures can be implemented to facilitate the functionality described herein. In various embodiments, the software 902 is implemented by hardware such as machine 1100 of FIG. 11 that includes processors 1110, memory 1130, and input/output (I/O) components 1130. In this example architecture, the software 1002 can be conceptualized as a stack of layers where each layer may provide a particular functionality. For example, the software 1002 includes layers such as an operating system 1004, libraries 1006, frameworks 1008, and applications 1010. Operationally, the applications 1010 invoke API calls 1012 through the software stack and receive messages 1014 in response to the API calls 1012, in accordance with some embodiments.

In some embodiments, the operating system 1004 manages hardware resources and provides common services. The operating system 1004 includes, for example, a kernel 1020, services 1022, and drivers 1024. The kernel 1020 acts as an abstraction layer between the hardware and the other software layers consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH drivers, flash memory drivers, serial communication drivers (e.g., Universal Serial Bus (USB) drivers), WI-FI drivers, audio drivers, power management drivers, and so forth. In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematics functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various graphic user interface (GUI) functions, high-level resource management, high-level location services, and so forth. The frameworks 1008 can provide a broad spectrum of other APIs that can be utilized by the applications 1010, some of which may be specific to a particular operating system 1004 or platform. In an example embodiment, the applications 1010 include a home application 1050, a contacts application 1052, a browser application 1054, a search/discovery application 1056, a location application 1058, a media application 1060, a messaging application 1062, a security device application 1064, and other applications such as a third party application 1066. According to some embodiments, the applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third party application 1066 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 1066 can invoke the API calls 1012 provided by the operating system 1004 to facilitate functionality described herein. The security device application 1067 may implement any system or method described herein, including provisioning, administering, verifying, creating, generating, authenticating security devices or any other operation described herein.

FIG. 11 is a block diagram illustrating components of a machine 1100, according to some example embodiments, able to read a set of instructions from a machine-readable medium (e.g., a machine-readable storage medium) and perform any one or more of the methodologies discussed herein.

Specifically, FIG. 11 shows a diagrammatic representation of the machine 1100 in the example form of a computer system, within which instructions 1016 (e.g., software, a program, an application, an applet, an app, or other executable code) for causing the machine 1000 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described. In alternative embodiments, the machine 1100 operates as a standalone device or can be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein. The machine 1100 can include processors 1110, memory/storage 1130, and I/O components 1150, which can be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1112 and processor 1114 that may execute instructions 1116. The term “processor” is intended to include multi-core processor that may comprise two or more independent processors (sometimes referred to as “cores”) that can execute instructions contemporaneously. Although FIG. 11 shows multiple processors, the machine 1100 may include a single processor with a single core, a single processor with multiple cores (e.g., a multi-core processor), multiple processors with a single core, multiple processors with multiples cores, or any combination thereof. The memory/storage 1130 can include a main memory 1132, a static memory 1134, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 can also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of the processors 1110 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 1116. The term “machine-readable medium” or “machine-readable storage medium” shall also be taken to include any medium, or combination of multiple media, that is capable of storing, encoding or carrying a set of instructions (e.g., instructions 1116) for execution by a machine (e.g., machine 1100), such that the instructions, when executed by one or more processors of the machine 1100 (e.g., processors 1111), cause the machine 1100 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure. Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 1150 can include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 can include many other components that are not shown in FIG. 11. The I/O components 1150 are grouped according to functionality merely for simplifying the following discussion and the grouping is in no way limiting. In example embodiments, the I/O components 1150 can include output components 1152 and input components 1154. The output components 1152 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 1152 can include biometric components 1156, motion components 1158, environmental components 1160, or position components 1162 among a wide array of other components. For example, the biometric components 1156 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 can include acceleration sensor components (e.g., an accelerometer), gravitation sensor components, rotation sensor components (e.g., a gyroscope), and so forth. The environmental components 1160 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1162 can include location sensor components (e.g., a GPS receiver component), altitude sensor components (e.g., altimeters or barometers that detect air pressure from which altitude may be derived), orientation sensor components (e.g., magnetometers), and the like. Communication can be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 include a network interface component or other suitable device to interface with the network 1180. In further examples, communication components 1164 include wired communication components, wireless communication components, cellular communication components, Near Field Communication (NFC) components, Bluetooth. components (e.g., Bluetooth. Low Energy), WI-FI components, and other communication components to provide communication via other modalities. The devices 1170 may be another machine or any of a wide variety of peripheral devices (e.g., a peripheral device coupled via a USB). The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 1164 can detect identifiers or include components operable to detect identifiers. For example, the communication components 1164 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1164, such as location via Internet Protocol (IP) geo-location, location via WI-FI signal triangulation, location via detecting a BLUETOOTH or NFC beacon signal that may indicate a particular location, and so forth. In various example embodiments, one or more portions of the network 1180 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI®. network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or other type of cellular or wireless coupling. In this example, the coupling 1182 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 can be transmitted or received over the network 1180 using a transmission medium via a network interface device (e.g., a network interface component included in the communication components 1164) and utilizing any one of a number of transfer protocols (e.g., HTTP). Similarly, the instructions 1116 can be transmitted or received using a transmission medium via the coupling 1172 (e.g., a peer-to-peer coupling) to devices 1170. The term “transmission medium” shall be taken to include any intangible medium that is capable of storing, encoding, or carrying the instructions 1116 for execution by the machine 1100, and includes digital or analog communications signals or other intangible medium to facilitate communication of such software. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed. The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled. As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. The teachings of the disclosure provided herein can be applied to other systems, not necessarily the system described above. The elements and acts of the various embodiments described above can be combined to provide further embodiments. Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”.) Accordingly, the applicant reserves the right to add additional claims after filing the application to pursue such additional claim forms for other aspects of the disclosure.

1. A method to authenticate a security device, the method, comprising:
capturing, by an optical sensor, sequential image frames of the security device;
measuring, from the sequential image frames of the security device, changes to an optical property of the security device, the optical property including an optical refractive property;
identifying changes in optical refractive properties of the security device from the changes to the optical property measured from the security device;
determining whether the changes in the optical property matches or fails to match a valid change, the valid change being predetermined for the optical property.

2. The method of claim 1, wherein:
the valid change is determined from a change in shape of a microlens symbol of the security device in response to a change in position of the optical sensor relative to the security device;
the change in the shape of the microlens symbol includes one or more of, an appearance of the shape, a disappearance of the shape and a change in the shape from one to another.

3. The method of claim 1, wherein:
the valid change is determined from a change in a perceived depth of a microlens symbol of the security device from a surface of the security device;
wherein the surface of the security device is optically detectable by the optical sensor during measurement.

4. The method of claim 1, wherein:
the valid change is determined from a change in spatial frequency of an emergent periodic pattern resulting from superposition of two or more periodic patterns of the security device;
wherein, the two or more periodic patterns are formed in a transparent microlens layer of the security device.

5. The method of claim 1, wherein:
the valid change is determined from a change in spatial frequency of an emergent periodic pattern resulting from superposition of multiple periodic patterns of the security device;
wherein, a first periodic pattern of the multiple periodic patterns is printed behind a transparent microlens layer of the security device, and a second one of the periodic patterns is formed within the transparent microlens layer.

6. The method of claim 1, wherein:
the valid change is determined from a change in spatial frequency of a periodic pattern of repetition of a microlens symbol on the security device.

7. The method of claim 1, further comprising:
determining the valid change using a distance by which a microlens symbol shifts in a 2D plane of the security device measured per unit change in a rotational position or lateral position of the optical sensor relative to the security device.

8. The method of claim 7, wherein:
the valid change is ascertained using (i) a curvature angle of a microlens or the security device and (ii) a refractive index of glass substrate.

9. The method of claim 1,
wherein, the valid change is determined from:
a distance by which a microlens symbol shifts in a 2D plane of the security device measured per unit change in a rotational position of the optical sensor relative to the security device;
wherein, the distance includes a horizontal lateral distance or a vertical planar distance;
wherein, the rotational position is specified in by one or more of a pitch, roll and yaw of the optical sensor.

10. The method of claim 1,
wherein, the valid change is determined from:
a distance by which a microlens symbol shifts in a 2D plane of the security device measured per unit change in a lateral position of the optical sensor;
wherein, the distance includes a horizontal lateral distance or a vertical planar distance;
wherein, the lateral position is specified one or more of an x, y and z position of the optical sensor.

11. The method of claim 1,
wherein, two or more sequential image frames are captured.

12. The method of claim 1,
wherein, a first image frame of the sequential image frames is captured when the optical sensor is positioned at a first angle with respect to the security device;
wherein, a second image frame of the sequential image frames is captured when the optical sensor is positioned at a second angle with respect to the security device;
wherein the first angle is different from the second angle.

13. (canceled)

14. The method of claim 1,
further wherein, the security device includes, one or more of, a lens array, a microlens array, a nanolens array, a 2D lens array and a 3D lens array.

15.-16. (canceled)

17. A system to authenticate a security device, the system, comprising:
an optical sensor to capture sequential image frames of the security device;
an authentication and verification engine operably coupled to the optical sensor;
wherein, the authentication and verification engine measures, from the sequential image frames of the security device, changes to an optical property of the security device, the optical property including an optical refractive property;
wherein, the authentication and verification engine further identifies changes in optical refractive properties of the security device from the changes to the optical property measured from the security device;
wherein, the authentication and verification engine further determines the changes in the optical property matches or fails to match a valid change, the valid change being predetermined for the optical property.

18. The method of claim 17, wherein:
the valid change is determined from a change in one or more of:
(i) shape of a microlens symbol of the security device in response to a change in position of the optical sensor relative to the security device;
(ii) a perceived depth of a microlens symbol of the security device from a surface of the security device;
(iii) spatial frequency of an emergent periodic pattern resulting from superposition of two or more periodic patterns of the security device.

19.-20. (canceled)

21. A method to authenticate a security device, the method, comprising:
acquiring, by an optical sensor, a first image and a second image of the security device;
comparing the first image to the second image of the security device, to detect changes to an optical property in the first image and the second image;
determining whether the changes in the optical property matches or fails to match a valid change, the valid change being predetermined for the optical property;
wherein:
at least one of the first and second images includes a recognized optical feature;
further wherein, the changes in the optical property is determined from the recognized optical feature.

22. The method of claim 21, wherein:
the recognized optical feature includes a recognized optically stationary feature and a recognized optically non-stationary feature;
wherein, the change in the optical property is determined by analyzing changes in position between the recognized optically stationary feature and the recognized optically non-stationary feature as the optical sensor and the security device are moved in relation to one another.

23. The method of claim 21, wherein:
the recognized optically stationary feature includes a visible identifier;
wherein, the recognized optically non-stationary feature includes an optically diffractive surface.

24. The method of claim 21, wherein:
the recognized optically stationary feature includes a visible identifier;
wherein, the recognized optically non-stationary feature includes a refractive lens, the refractive lens including a microlens or 3D lens.

25. The method of claim 21, wherein:
the recognized optical feature includes a first recognized optically non-stationary feature and a second recognized optically non-stationary features;
wherein, the change in the optical property is determined by analyzing changes in position between the first recognized optically non-stationary feature and the second recognized optically non-stationary features as the optical sensor and the security device are moved in relation to one another.

26.-32. (canceled)
